(19) United States
(12) Patent Application Publication
(10) Pub. No.: US 2025/0334782 A1
(43) Pub. Date: Oct. 30, 2025

(54) OPTICAL STRUCTURE AND DISPLAY DEVICE

(71) Applicant: Beijing Zitiao Network Technology Co., Ltd., Beijing (CN)

(72) Inventors: Xuan ZHONG, Beijing (CN); Xin LI, Beijing (CN); Xiaokai LI, Beijing (CN); Shaopeng ZHU, Beijing (CN); Zhao ZHANG, Beijing (CN); Xiaofei JIA, Beijing (CN)

(21) Appl. No.: 18/991,309

(22) Filed: Dec. 20, 2024

(30) Foreign Application Priority Data
Apr. 24, 2024 (CN) 202410501404.2

(51) Int. Cl. G02B 17/08; G02B 27/28

(52) U.S. Cl. CPC G02B 17/0856; G02B 27/28

(57) ABSTRACT

An optical structure and a display device are provided. The optical structure includes a lens, a transflective film, a reflective polarizing layer, and a first phase retardation film group. The first phase retardation film group includes a first phase retardation film and a second phase retardation film. The second phase retardation film is between the first phase retardation film and the transflective film. The first phase retardation film has a phase retardation of 200 to 280 nm, and the second phase retardation film has a phase retardation of 80 to 170 nm. An included angle between a slow axis of the first phase retardation film and a reflection axis of the reflective polarizing layer ranges from 90 to 180 degrees, and an included angle between a slow axis of the second phase retardation film and the reflection axis of the reflective polarizing layer ranges from 135 to 315 degrees.

The present application claims priority to Chinese Patent Application No. 2024105014042, filed on Apr. 24, 2024, the disclosure of which is incorporated herein in its entirety as part of the present application.

### TECHNICAL FIELD

Embodiments of the present disclosure relate to an optical structure and a display device.

### BACKGROUND

Virtual Reality (VR) display products may use a folded optical path (Pancake) design to achieve a short-focus optical design. Pancake compresses the total optical length (TTL) of VR, making it the best choice for lightweight head-mounted display products. The principle of the folded optical path design consists in that after image light emitted from a screen passes through a beam splitter with a semi-transmissive and semi-reflective function, light is folded back between a lens, a phase compensation film, and a reflective polarizer for many times, and finally exits from the reflective polarizer and enters the human eyes.

### SUMMARY

Embodiments of the present disclosure provide an optical structure and a display device.

Embodiments of the present disclosure provide an optical structure, including: at least one lens, a transflective film, a reflective polarizing layer, and a first phase retardation film group. The transflective film is located on a first surface of the at least one lens; the reflective polarizing layer is located on a second surface of the at least one lens; and the first phase retardation film group is located on a side of the first surface away from the transflective film. The first phase retardation film group includes a first phase retardation film and a second phase retardation film. The second phase retardation film is located between the first phase retardation film and the transflective film. The first phase retardation film has a phase retardation R01 of 200 to 280 nm, and the second phase retardation film has a phase retardation R02 of 80 to 170 nm. An included angle between a slow axis of the first phase retardation film and a reflection axis of the reflective polarizing layer ranges from 90 to 180 degrees, and an included angle between a slow axis of the second phase retardation film and the reflection axis of the reflective polarizing layer ranges from 135 to 315 degrees. The first phase retardation film and the second phase retardation film each include in-plane refractive indices in two different directions, the difference between the two different refractive indices of the first phase retardation film is Δn1, the difference between the two different refractive indices of the second phase retardation film is Δn2, Δn1, R01 and a thickness d1 of the first phase retardation film satisfy the relationship: R01=Δn1*d1, and Δn2, R02 and a thickness d2 of the second phase retardation film satisfy the relationship: R02=Δn2*d2.

For example, according to an embodiment of the present disclosure, the first phase retardation film has a phase retardation of 202 to 249 nm, and the second phase retardation film has a phase retardation of 102 to 128 nm.

For example, according to an embodiment of the present disclosure, the included angle between the slow axis of the first phase retardation film and the reflection axis of the reflective polarizing layer ranges from 97 to 112 degrees, and the included angle between the slow axis of the second phase retardation film and the reflection axis of the reflective polarizing layer ranges from 149 to 179 degrees.

For example, according to an embodiment of the present disclosure, an included angle between the slow axis of the first phase retardation film and the slow axis of the second phase retardation film ranges from 45 to 135 degrees.

For example, according to an embodiment of the present disclosure, the included angle between the slow axis of the first phase retardation film and the slow axis of the second phase retardation film ranges from 51 to 67 degrees.

For example, according to an embodiment of the present disclosure, the first phase retardation film and the second phase retardation film each include three refractive indices in three directions perpendicular to each other, the three refractive indices including a first refractive index, a second refractive index, and a third refractive index; the first refractive index is the highest in-plane refractive index of the first phase retardation film and the second phase retardation film, the second refractive index is the lowest in-plane refractive index of the first phase retardation film and the second phase retardation film, and the third refractive index is a refractive index of the first phase retardation film and the second phase retardation film in a thickness direction; the first refractive index Nx1, the second refractive index Ny1, the third refractive index Nz1 and the thickness d1 of the first phase retardation film satisfy the relationship: Nx1>Ny1, and (Ny1−Nz1)*d1*1000<20 nm, where Δn1=Nx1−Ny1; and the first refractive index Nx2, the second refractive index Ny2, the third refractive index Nz2 and the thickness d2 of the second phase retardation film satisfy the relationship: Nx2>Ny2, and (Ny2−Nz2)*d2*1000<20 nm, where Δn2=Nx2−Ny2.

For example, according to an embodiment of the present disclosure, the first phase retardation film and the second phase retardation film are each made of a material that has a positive dispersion with respect to wavelength.

For example, according to an embodiment of the present disclosure, the first phase retardation film includes a half-wave plate, and the second phase retardation film includes a quarter-wave plate.

For example, according to an embodiment of the present disclosure, the first phase retardation film group further includes a third phase retardation film including three refractive indices in three directions perpendicular to each other, the three refractive indices including a fourth refractive index Nx3, a fifth refractive index Ny3, and a sixth refractive index Nz3; and the fourth refractive index and the fifth refractive index are in-plane refractive indices of the third phase retardation film, the sixth refractive index is a refractive index of the third phase retardation film in a thickness direction, and a thickness d3 of the third phase retardation film, Nx3, Ny3 and Nz3 satisfy the relationship: Ny3<Nz3, and (Nx3−Ny3)*d3*1000<20 nm.

For example, according to an embodiment of the present disclosure, the third phase retardation film has a phase retardation Rth1 of −50 to −150 nm in the thickness direction; and Rth, d3, Nx3, Ny3 and Nz3 satisfy the relationship: Rth1=[(Nx3+Ny3)/2−Nz3]*d3.

For example, according to an embodiment of the present disclosure, the third phase retardation film has a phase retardation Rth1 of −70 to −110 nm in the thickness direction.

For example, according to an embodiment of the present disclosure, the optical structure further includes: a first linear polarizing layer located on a side of the reflective polarizing layer away from the transflective film. An included angle between the slow axis of the first phase retardation film and an absorption axis of the first linear polarizing layer ranges from 90 to 180 degrees.

An embodiment of the present disclosure provides a display device, including a display, and an optical structure as described above, wherein the optical structure is located on a light exit side of the display, and the transflective film is located between the display and the reflective polarizing layer.

For example, according to an embodiment of the present disclosure, a second phase retardation film group and a second linear polarizing layer are provided between the display and the optical structure, an absorption axis of the second linear polarizing layer being orthogonal to the reflection axis of the reflective polarizing layer; and the second phase retardation film group includes at least a fourth phase retardation film and a fifth phase retardation film, the fifth phase retardation film being located between the fourth phase retardation film and the optical structure, a slow axis of the fourth phase retardation film being orthogonal to the slow axis of the first phase retardation film, and a slow axis of the fifth phase retardation film being orthogonal to the slow axis of the second phase retardation film.

For example, according to an embodiment of the present disclosure, the fourth phase retardation film has a phase retardation R04 of 200 to 280 nm, and the fifth phase retardation film has a phase retardation R05 of 80 to 170 nm; and the fourth phase retardation film and the fifth phase retardation film each include in-plane refractive indices in two different directions, the difference between the two different refractive indices of the fourth phase retardation film is Δn4, the difference between the two different refractive indices of the fifth phase retardation film is Δn5, Δn4, R04 and a thickness d4 of the fourth phase retardation film satisfy the relationship: R04=Δn4*d4, and Δn5, R05 and a thickness d5 of the fifth phase retardation film satisfy the relationship: R05=Δn5*d5.

For example, according to an embodiment of the present disclosure, the fourth phase retardation film has a phase retardation of 202 to 249 nm, and the fifth phase retardation film has a phase retardation of 102 to 128 nm.

For example, according to an embodiment of the present disclosure, an included angle between the slow axis of the fourth phase retardation film and a transmission axis of the second linear polarizing layer ranges from 0 to 90 degrees, and an included angle between the slow axis of the fifth phase retardation film and the transmission axis of the second linear polarizing layer ranges from 45 to 225 degrees.

For example, according to an embodiment of the present disclosure, the fourth phase retardation film and the fifth phase retardation film are each made of a material that has a positive dispersion with respect to wavelength.

For example, according to an embodiment of the present disclosure, the fourth phase retardation film includes a half-wave plate, and the fifth phase retardation film includes a quarter-wave plate.

For example, according to an embodiment of the present disclosure, the second phase retardation film group further includes a sixth phase retardation film, the sixth phase retardation film having a phase retardation Rth2 of −50 to −150 nm in a thickness direction thereof; the sixth phase retardation film includes three refractive indices in three directions perpendicular to each other, the three refractive indices including a fourth refractive index Nx4, a fifth refractive index Ny4, and a sixth refractive index Nz4; the fourth refractive index and the fifth refractive index are in-plane refractive indices of the sixth phase retardation film, the sixth refractive index is a refractive index of the sixth phase retardation film in a thickness direction, and the thickness d6 of the sixth phase retardation film, Nx4, Ny4 and Nz4 satisfy the relationship: Ny4<Nz4, and (Nx4−Ny4)*d6*1000<20 nm; and Rth2, d6, Nx4, Ny4, and Nz4 satisfy the relationship: Rth2=[(Nx4+Ny4)/2−Nz4]*d6.

### BRIEF DESCRIPTION OF DRAWINGS

In order to illustrate the technical solutions of the embodiments of the present disclosure more clearly, the drawings of the embodiments will be briefly introduced below. Obviously, the drawings in the following description only relate to some embodiments of the present disclosure, and are not intended to limit the present disclosure.

FIG. 1 is a schematic view of a display device using a folded optical path.

FIGS. 2 to 4 are diagrams of optical paths with ghosting generated by the display device shown in FIG. 1.

FIGS. 5 and 6 are schematic views of another display device using a folded optical path.

FIG. 7 shows an angular relationship between a slow axis of a phase retarder and an absorption axis of a linear polarizer provided on a lens in the display device shown in FIG. 5.

FIG. 8 shows an angular relationship between a slow axis of a phase retarder and an absorption axis of a linear polarizer provided on a display in the display device shown in FIG. 5.

FIG. 9 is a schematic cross-sectional view of an optical structure according to an embodiment of the present disclosure.

FIG. 10 shows an angular relationship among a slow axis of a first phase retardation film, a slow axis of a second phase retardation film, and a reflection axis of a reflective polarizing layer in the optical structure shown in FIG. 9.

FIG. 11 is a schematic view of a display device according to another embodiment of the present disclosure.

FIG. 12 is a schematic view of a display device according to an example of another embodiment of the present disclosure.

FIG. 13 shows an angular relationship among a slow axis of a third phase retardation film, a slow axis of a fourth phase retardation film, and a transmission axis of a second linear polarizing layer in the display device shown in FIG. 12.

FIG. 14 is a curve of a variation of an energy ratio between a ghosting and a main image as an included angle between the slow axis of the fourth phase retardation film and the transmission axis of the second linear polarizing layer changes.

FIG. 15 is a curve of a variation of an energy ratio of a ghosting to a main image as a phase retardation of the first phase retardation film changes.

FIG. 16 is a curve of a variation of an energy ratio of a ghosting to a main image as a phase retardation of the second phase retardation film changes.

FIG. 17A is a diagram of a main image of the display device shown in FIG. 5 in a full field of view.

FIG. 17B is a diagram of energy distribution of direct ghosting in the full field of view in the display device shown in FIG. 5.

FIG. 17C shows the level of direct ghosting of the display device shown in FIG. 5 in the full field of view.

FIG. 17D is a diagram of energy distribution of stray light caused by folded ghosting in the display device shown in FIG. 5 in the full field of view.

FIG. 17E shows the level of stray light of the display device shown in FIG. 5 in the full field of view.

FIG. 18A is a diagram of a main image of a display device in a full field of view in a first example.

FIG. 18B is a diagram of energy distribution of direct ghosting in the full field of view in the display device in the first example.

FIG. 18C shows the level of direct ghosting of the display device in the full field of view in the first example.

FIG. 18D is a diagram of energy distribution of stray light caused by folded ghosting in the display device in the full field of view in the first example.

FIG. 18E shows the level of stray light in the full field of view in the first example.

FIG. 19A is a diagram of a main image of a display device in a full field of view in a second example.

FIG. 19B is a diagram of energy distribution of direct ghosting in the full field of view in the display device in the second example.

FIG. 19C shows the level of direct ghosting of the display device in the full field of view in the second example.

FIG. 19D is a diagram of energy distribution of stray light caused by folded ghosting in the display device in the full field of view in the second example.

FIG. 19E shows the level of stray light in the full field of view in the second example.

### DETAILED DESCRIPTION

In order to make the objects, technical solutions and advantages of embodiments of the present disclosure clearer, the technical solutions in the embodiments of the present disclosure will be clearly and completely described below with reference to the drawings of the embodiments of the present disclosure. Apparently, the described embodiments are some rather than all of the embodiments of the present disclosure. Based on the described embodiments of the present disclosure, all other embodiments obtained by those of ordinary skill in the art without involving any inventive effort fall within the scope of protection of the present disclosure.

Unless otherwise defined, the technical or scientific terms used in the present disclosure shall have general meanings as understood by those of ordinary skill in the art to which the present disclosure pertains. “First”, “second”, and like words used in the present disclosure do not indicate any order, quantity, or importance, but are merely used to distinguish between different components. “Include” or “comprise” or like words mean that an element or item preceding the term encompasses an element or item or its equivalent listed after the term, without excluding other elements or items.

In the embodiments of the present disclosure, the features, “parallel to”, “perpendicular to”, “identical to”, etc., all include the features “parallel to”, “perpendicular to”, “the same”, etc., in the strict sense, as well as the cases containing certain errors, such as “approximately parallel to”, “approximately perpendicular to”, “approximately the same”, etc. Considering the measurement and the errors related to the measurement of a specific quantity (e.g., the limitation of a measurement system), they are within an acceptable deviation range for the specific quantity determined by those of ordinary skill in the art. For example, the term “approximately” can mean within one or more standard deviations, or within 10% or 5% deviation of the stated value. When the quantity of a component is not specified in the following description of the embodiments of the present disclosure, it means that the number of the component can be one or more, or can be understood as at least one. The phrase “at least one” means one or more, and the phrase “a plurality of” means at least two.

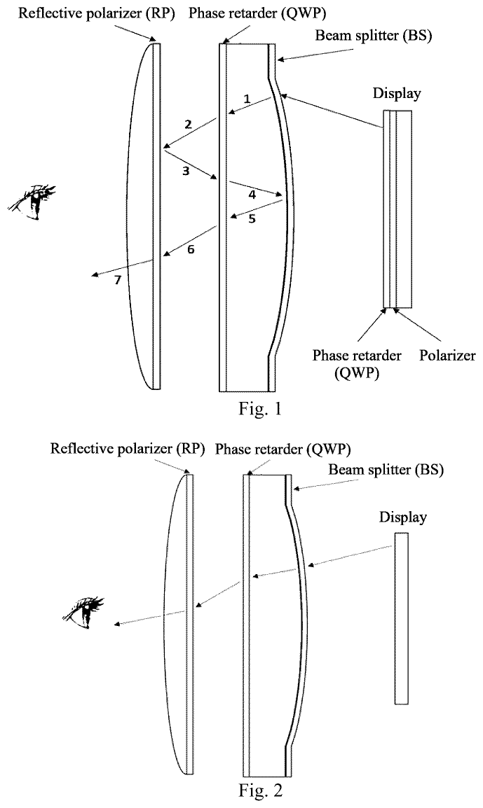

FIG. 1 is a schematic view of a display device using a folded optical path. FIGS. 2 to 4 are diagrams of optical paths with ghosting generated by the display device shown in FIG. 1.

As shown in FIG. 1, a display device having a folded optical path, such as a display device having a Pancake structure, has an optical path as follows: image light from a display passes through a phase retarder (QWP) and a polarizer which are located on a light exit surface of the display, and is converted into circularly polarized light, such as right circularly polarized light. This right circularly polarized light is shown as light 1 after being transmitted through a beam splitter (BS). Compared with the circularly polarized light before incident on the beam splitter, the polarization state of the light 1 remains unchanged, but the light intensity is lost by 50%. The light 1 passes through a phase retarder (QWP) on a lens and is then converted into horizontal linearly polarized light, as represented by light 2. The linearly polarized light is reflected by a reflective polarizer (RP) and becomes light 3, which passes through the phase retarder and is converted into right circularly polarized light, as represented by light 4. The light 4 is reflected by the beam splitter and becomes left circularly polarized light, as represented by light 5. The light 5 passes through the phase retarder and is converted into vertical linearly polarized light, as represented by light 6. The light 6 is transmitted through a reflective polarizer and becomes light 7, which then enters a human eye.

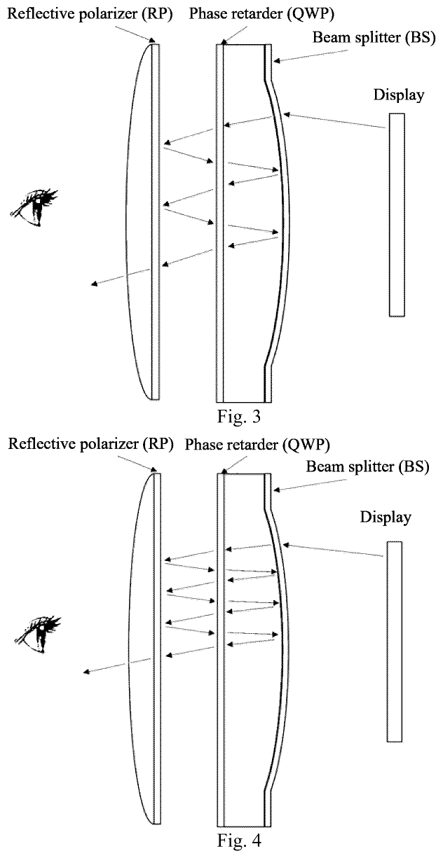

Although the Pancake structure has many advantages such as reduced thickness and weight and improved imaging quality, it also has defects such as ghosting and stray light. The form of the ghosting generated by the Pancake structure includes direct ghosting as shown in FIG. 2 and ghosting folded twice or more as shown in FIGS. 3 to 4. The phase retarder and the polarizer between the display and the beam splitter are omitted from FIGS. 2 to 4.

As shown in FIG. 2, part of the light passing through the beam splitter (BS) and the phase retarder (QWP) and reaching the reflective polarizer (RP) is not converted into reflectable linearly polarized light (e.g., horizontal linearly polarized light). This part of light is not folded between the beam splitter and the reflective polarizer, but is directly transmitted through the reflective polarizer and enters the human eye. The ghosting formed by this part of direct light is called direct ghosting.

As shown in FIG. 3, when the light that is folded between the beam splitter (BS) and the reflective polarizer (RP) under the effects of reflection thereof reaches the reflective polarizer for the second time, part of the light is not converted into transmittable linearly polarized light (e.g., vertical linearly polarized light). This part of light does not pass through the reflective polarizer and enter the human eye according to a preset path, but is reflected and enters the folded optical path again. This part of light is transmitted when it reaches the reflective polarizer for the third time and forms ghosting, which is called folded ghosting.

As shown in FIG. 4, part of the light is not transmitted through the reflective polarizer when it reaches the reflective polarizer for the second time according to the preset path, but is transmitted when it reaches the reflective polarizer for the fourth time, and forms ghosting, which is also called folded ghosting.

Referring to FIGS. 1 to 4, it can be seen from the principle of the formation of main image and ghosting paths that the main causes for the ghosting and stray light include the following points, such as the dispersion effect of the phase retarder provided on the lens, for example, the refractive index changing with wavelength; the beam splitting properties of the beam splitter, for example, the beam splitter having different transmittances for two polarized lights with different characteristics, namely, linearly p-polarized light and linearly s-polarized light; and the presence of different incident angles when the light emitted from the display is incident on the phase retarder provided on the lens. All of the above causes may affect the ability of the phase retarder provided on the lens to achieve ideal phase compensation of π/2 for a full range of wavelength bands of light, whereby circularly polarized light incident on the beam splitter cannot be converted into ideal linearly polarized light by the phase retarder provided on the lens. That is, linearly polarized light and circularly polarized light in the pancake optical path are not converted ideally, forming ghosting and stray light.

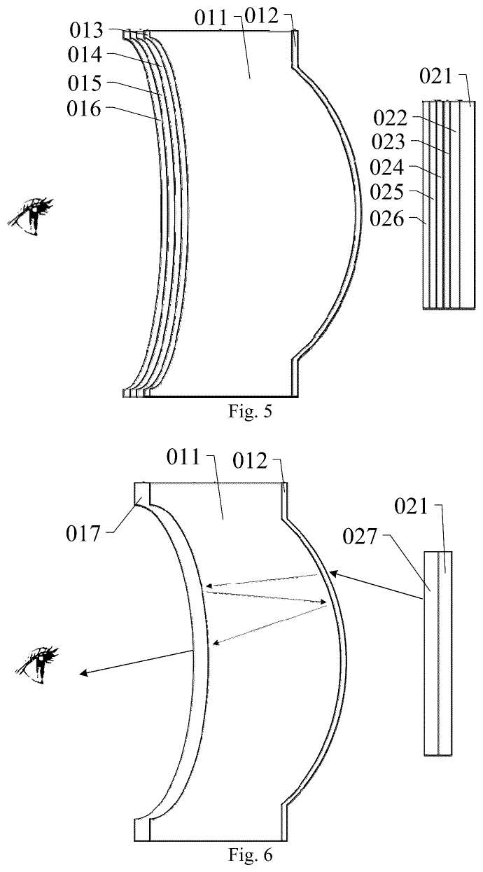

FIGS. 5 and 6 are schematic views of another display device using a folded optical path.

As shown in FIG. 5, the display device includes a lens 011 and a display 021, with the human eye on a side of lens 011 away from the display 021. A surface of the lens 011 facing the display 021 is provided with a beam splitter 012, a surface of the display 021 facing the lens 011 is provided with an anti-reflective structure 022, a linear polarizer 023, a compensation film 024, a phase retarder 025 and an anti-reflective structure 026, and a surface of the lens 011 away from the display 021 is provided with a compensation film 013, a phase retarder 014, a reflective polarizer 015 and a linear polarizer 016 in sequence. For example, the phase retarder 025 and the phase retarder 014 as mentioned above may both be quarter-wave plates. For example, the display 021 as mentioned above may be a liquid crystal display (LCD), but is not limited thereto. When the display is an organic light-emitting diode display (OLED), a phase retarder, such as a quarter-wave plate, may be provided between the linear polarizer 016 and the display 021 to achieve the anti-reflective function.

FIG. 6 shows a schematic diagram of an optical path of the display device shown in FIG. 5. A film layer 017 in FIG. 6 includes the compensation film 013, the phase retarder 014, the reflective polarizer 015, and the linear polarizer 016 shown in FIG. 5, and a film layer 027 in FIG. 6 includes the anti-reflective structure 022, the linear polarizer 023, the compensation film 024, the phase retarder 025, and the anti-reflective structure 026 shown in FIG. 5.

FIGS. 5 and 6 schematically show that the display device includes one lens 011, but not limited thereto. It is also possible that the display device shown in FIG. 1 includes two lens, or includes more than two lenses.

As shown in FIGS. 5 and 6, the phase retarder provided on the lens and the phase retarder provided on the display in a general display device are each made of a material having reverse wavelength dispersion characteristics. For example, the two phase retarders each have the characteristics that the refractive index increases as the wavelength increases, and are each made of a single-layer material. The selection of the material of such phase retarders and the number of film layers results in an unsatisfactory effect of conversion between a linear polarization state and a circular polarization state of the light in the folded optical path, and a high degree of ghosting and stray light.

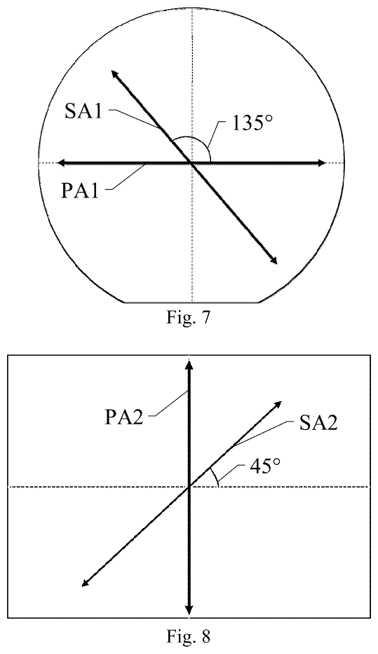

FIG. 7 shows an angular relationship between a slow axis of the phase retarder and an absorption axis of the linear polarizer provided on the lens in the display device shown in FIG. 5. FIG. 8 shows an angular relationship between a slow axis of the phase retarder and an absorption axis of the linear polarizer provided on the display in the display device shown in FIG. 5.

As shown in FIGS. 5 and 7, the absorption axis PA1 of the linear polarizer 016 is in a direction in which the linear polarizer 016 has the highest light absorptance, that is, in a direction in which the transmittance is lowest. The linear polarizer 016 includes a transmission axis perpendicular to the absorption axis. The transmission axis is in a direction in which the light transmittance is highest. When the polarization direction of the linearly polarized light is perpendicular to the absorption axis, the linearly polarized light can penetrate the linear polarizer 016 to the greatest extent. An included angle between the absorption axis of the linear polarizer 016 and a reflection axis of the reflective polarizer 015 is 0 degrees, and an included angle between the transmission axis of the linear polarizer 016 and a transmission axis of the reflective polarizer 015 is 0 degrees. The slow axis SA1 of the phase retarder 014 is in a direction in which one of polarized components of the light propagates at a slower rate relative to the other component, such as the direction in which the refractive index is greater. From the direction in which the human eye looks at the display, the absorption axis PA1 of the linear polarizer 016 is 0 degrees and the slow axis SA1 of the phase retarder 014 is 135 degrees. That is, the included angle between the slow axis SA1 of the phase retarder 014 and the absorption axis PA1 of the linear polarizer 016 is 135 degrees, and the included angle between the slow axis SA1 of the phase retarder 014 and the reflection axis of the reflective polarizer 015 is 135 degrees.

As shown in FIG. 5, the phase retardation R0, the thickness d, the highest in-plane refractive index Nx, and the lowest in-plane refractive index Ny of each of the phase retarder 014 and the phase retarder 025 satisfy the relationship: R0=(Nx−Ny)*d. The phase difference Delta satisfies the relationship: Delta=2*π*R0/λ. The in-plane phase retardation R0 of each of the phase retarder 014 and the phase retarder 025 is about 141 nm, and the phase difference described here and later may refer to the phase difference at a particular wavelength λ. For example, λ may be 550 nm. For example, the compensation film 013 and the compensation film 024 may both be positive C films, such as out-of-plane phase retardation compensation films. The positive C film has in-plane refractive indices Nx and Ny, and a refractive index Nz in the thickness direction, the phase retardation Rth of each of the compensation film 013 and the compensation film 024 in the thickness direction thereof, such as in the direction parallel to an optical axis of the lens 011, Nx, Ny, Nz and the thickness d satisfy the relationship: Rth=[(Nx+Ny)/2−Nz]*d. For example, the compensation film 013 and the compensation film 024 each have a phase retardation Rth of −100 nm.

As shown in FIGS. 5 and 8, from the direction in which the human eye looks at the display, the absorption axis PA2 of the linear polarizer 023 is 90 degrees and the slow axis SA2 of the phase retarder 025 is 45 degrees.

As shown in FIGS. 7 and 8, the absorption axis PA1 of the linear polarizer 016 is orthogonal to the absorption axis PA2 of the linear polarizer 023, and the slow axis SA1 of the phase retarder 014 is orthogonal to the slow axis SA2 of the phase retarder 025.

During the research, the inventors of the present application have found that in a general folded optical path, e.g., in the folded optical path as shown in FIGS. 1 and 6, the phase retarder provided on the lens and the phase retarder provided on the display are each of a single-layer structure to enable conversion between linearly polarized light and circularly polarized light. This structure is simple to make, but is greatly affected by the material dispersion effect. The phase retardation of a general phase retarder is designed for a wavelength band of more than 500 nm. For example, the phase retardation designed for the 550 nm band is about 141 nm, and the phase retardation designed for the 589 nm band is about 144 nm. Therefore, the use of a single-layer phase retarder with reverse dispersion characteristics cannot achieve an ideal phase compensation of π/2 for higher and lower bands. Moreover, the beam splitting effect of the beam splitter in the folded optical path and the refraction of the lens, etc. as described above may lead to a lower ellipticity of the linearly polarized light after passing through the phase retarder, or a lower degree of linear polarization of the circularly polarized light after passing through the phase retarder, resulting in direct ghosting and/or folded ghosting as shown in FIGS. 2 to 4.

The present disclosure provides an optical structure and a display device. The optical structure includes at least one lens, a transflective film, a reflective polarizing layer, and a first phase retardation film group. The transflective film is located on a first surface of the at least one lens, the reflective polarizing layer is located on a second surface of the at least one lens, and the first phase retardation film group is located on a side of the first surface away from the transflective film. The first phase retardation film group includes at least a first phase retardation film and a second phase retardation film. The second phase retardation film is located between the first phase retardation film and the transflective film. The first phase retardation film has a phase retardation of 200 to 280 nm, and the second phase retardation film has a phase retardation of 80 to 170 nm. An included angle between a slow axis of the first phase retardation film and a reflection axis of the reflective polarizing layer ranges from 90 to 180 degrees, and an included angle between a slow axis of the second phase retardation film and the reflection axis of the reflective polarizing layer ranges from 135 to 315 degrees. The first phase retardation film and the second phase retardation film each include in-plane refractive indices in two different directions, the difference between the two different refractive indices of the first phase retardation film is Δn1, the difference between the two different refractive indices of the second phase retardation film is Δn2, Δn1, R01 and the thickness d1 of the first phase retardation film satisfy the relationship: R01=Δn1*d1, and Δn2, R02 and the thickness d2 of the second phase retardation film satisfy the relationship: R02=Δn2*d2.

The optical structure provided by the present disclosure improves the efficiency of conversion between circularly polarized light and linearly polarized light by matching two phase retardation films having specific phase retardations, and by setting the included angles between the slow axes of the first phase retardation film and the second phase retardation film and the reflection axis of the reflective polarizing layer, thereby effectively reducing ghosting and stray light of the folded optical path (pancake) caused by the unsatisfactory conversion of polarization states of the light.

The optical structure and the display device provided by the present disclosure will be described below with reference to the accompanying drawings.

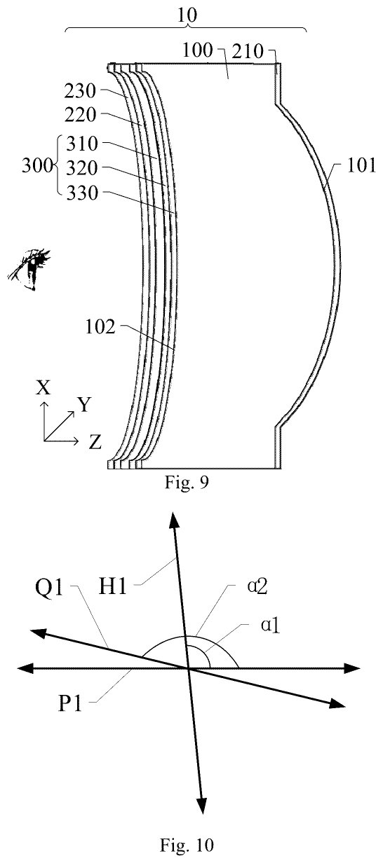

FIG. 9 is a schematic cross-sectional view of an optical structure according to an embodiment of the present disclosure.

As shown in FIG. 9, the optical structure includes at least one lens 100, a transflective film 210, a reflective polarizing layer 220, and a first phase retardation film group 300 located on the at least one lens 100. FIG. 9 schematically shows that the optical structure includes one lens 100, but is not limited thereto. It is also possible that the optical structure includes two or more lenses.

As shown in FIG. 9, the transflective film 210 is located on a first surface 101 of the at least one lens 100, the reflective polarizing layer 220 is located on a second surface 102 of the at least one lens 100, and the first phase retardation film group 300 is located on a side of the first surface 101 away from the transflective film 210. FIG. 9 schematically shows that the first surface 101 and the second surface 102 are two side surfaces of the same lens 100, but are not limited thereto. It is also possible that the first surface 101 and the second surface 102 are surfaces of different lenses 100. FIG. 9 schematically shows that the transflective film 210, the reflective polarizing layer 220, and the first phase retardation film group 300 are all located on the surfaces of the same lens 100, but are not limited thereto. The transflective film 210, the reflective polarizing layer 220 and the first phase retardation film group 300 may be provided on surfaces of different lenses 100 according to product requirements. For example, the first surface 101 and the second surface 102 are both curved surfaces. For example, at least one of the first surface 101 and the second surface 102 is at least one of a spherical surface, an aspherical surface, and a free-form surface. For example, the first surface 101 is a convex surface, and the second surface 102 is a concave surface.

For example, as shown in FIG. 9, the transflective film 210 is configured to transmit a part of the light and reflect the other part of the light. For example, the transflective film 210 may include at least one film layer. For example, each film layer may have a thickness of 10 to 200 nm. For example, the transflective film 210 may have a transmittance of 50% and a reflectance of 50%. For example, the transflective film 210 may have a transmittance of 60%, 65%, etc., and a reflectance of 40%, 35%, etc. The optical structure provided by the present disclosure is not limited to this, and the transmittance and reflectance of the transflective film may be set according to the product requirements.

For example, as shown in FIG. 9, the function of the reflective polarizing layer 220 is as follows: there is a transmission axis direction in the plane of the film layer, the transmittance of a polarized component (e.g., one of linearly s-polarized light and linearly p-polarized light) of the incident light parallel to the transmission axis direction is greater than the transmittance of a polarized component (e.g., the other one of the linearly s-polarized light and the linearly p-polarized light) perpendicular to the transmission axis direction, and the reflectance of the polarized component parallel to the transmission axis direction is less than the reflectance of the polarized component perpendicular to the transmission axis direction. For example, that reflective polarizing layer 220 may also be referred to as a polarizing beam splitting film. For example, the transmittance of the polarized light parallel to the transmission axis direction of the reflective polarizing layer 220 is not less than 85%, such as not less than 90%, such as not less than 95%, such as not less than 98%, and so on; and the reflectance of the polarized light perpendicular to the transmission axis direction of the reflective polarizing layer 220 is not less than 85%, such as not less than 90%, such as not less than 95%, such as not less than 98%, and so on. They may be set according to the product requirements.

For example, as shown in FIG. 9, the first phase retardation film group 300 is located between the transflective film 210 and the reflective polarizing layer 220. However, the present application is not limited to this. The first phase retardation film group 300 may be arranged on the side of the reflective polarizing layer 220 away from the transflective film 210, depending on the choice of material.

As shown in FIG. 9, the first phase retardation film group 300 includes at least a first phase retardation film 310 and a second phase retardation film 320. The second phase retardation film 320 is located between the first phase retardation film 310 and the transflective film 210. The first phase retardation film 310 has a phase retardation of 200 to 280 nm, and the second phase retardation film 320 has a phase retardation of 80 to 170 nm. An included angle between a slow axis of the first phase retardation film 310 and a reflection axis of the reflective polarizing layer 220 ranges from 90 to 180 degrees, and an included angle between a slow axis of the second phase retardation film 320 and the reflection axis of the reflective polarizing layer 220 ranges from 135 to 315 degrees. The first phase retardation film and the second phase retardation film each include in-plane refractive indices in two different directions, the difference between the two different refractive indices of the first phase retardation film is Δn1, the difference between the two different refractive indices of the second phase retardation film is Δn2, Δn1, R01 and the thickness d1 of the first phase retardation film satisfy the relationship: R01=Δn1*d1, and Δn2, R02 and the thickness d2 of the second phase retardation film satisfy the relationship: R02=Δn2*d2.

The expression “phase retardation of the first phase retardation film 310” described above can refer to the in-plane phase retardation R01 of 200 to 280 nm, and the expression “phase retardation of the second phase retardation film 320” described above can refer to the in-plane phase retardation R02 of 80 to 170 nm. The phase difference Delta1 of the first phase retardation film satisfies the relationship: Delta1=2*π*R01/λ, and the phase difference Delta2 of the second phase retardation film satisfies the relationship: Delta2=2*π*R02/λ. The phase difference described above can refer to the phase difference at a specific wavelength λ. For example, λ may be 550 nm.

The term “plane” described above can refer to the case when the phase retardation film is a planar film layer, considering that when the phase retardation film is arranged on the curved surface of the lens, the phase retardation as mentioned above will be shifted to a certain extent, but the shifted value is still within 200 to 280 nm and 80 to 170 nm. The slow axes of the first phase retardation film and the second phase retardation film are each in a direction in which one of polarized components of the light propagates at a slower rate relative to the other component, such as the direction in which the refractive index is greater. The reflection axis of the reflective polarizing layer is orthogonal to the transmission axis, and linearly polarized light parallel to the reflection axis of the reflective polarizing layer is reflected by the reflective polarizing layer.

The optical structure provided by the present disclosure improves the efficiency of conversion between circularly polarized light and linearly polarized light by matching two phase retardation films having specific phase retardations, and by setting the included angle between the slow axis of each of the two phase retardation films and the reflection axis of the reflective polarizing layer, thereby effectively reducing ghosting and stray light of the folded optical path (pancake) caused by the unsatisfactory conversion of polarization states of the light.

The optical structure provided by the present disclosure achieves the purpose of achromatic dispersion by providing in the optical structure a first phase retardation film group including at least a first phase retardation film and a second phase retardation film, where the first phase retardation film functions to perform phase pre-compensation on light of different wavelengths. The pre-compensation effect is related to the phase retardations of the first phase retardation film and the second phase retardation film, the included angles between the slow axes of the first phase retardation film and the second phase retardation film and the reflection axis of the reflective polarizing layer, etc., not only significantly improves the efficiency of conversion between circularly polarized light and linearly polarized light, but also has a high degree of matching with the transflective film and the refractive index of the lens, improving the achromatic dispersion effect while reducing the ghosting and stray light of the folded optical path (pancake).

FIG. 10 shows an angular relationship among the slow axis of the first phase retardation film, the slow axis of the second phase retardation film, and the reflection axis of the reflective polarizing layer in the optical structure shown in FIG. 9.

For example, as shown in FIGS. 9 and 10, the included angle α1 between the slow axis H1 of the first phase retardation film 310 and the reflection axis P1 of the reflective polarizing layer 220 ranges from 90 to 180 degrees, and the included angle α2 between the slow axis Q1 of the second phase retardation film 320 and the reflection axis P1 of the reflective polarizing layer 220 ranges from 135 to 315 degrees. Assuming that the reflection axis of the reflective polarizing layer 220 is at 0 degrees, the slow axis H1 of the first phase retardation film 310 is at an angle of 90 to 180 degrees, and the slow axis Q1 of the second phase retardation film 320 is at 135 to 315 degrees.

In some examples, as shown in FIGS. 9 and 10, the included angle α1 between the slow axis H1 of the first phase retardation film 310 and the reflection axis P1 of the reflective polarizing layer 220 ranges from 97 to 112 degrees, and the included angle α2 between the slow axis Q1 of the second phase retardation film 320 and the reflection axis P1 of the reflective polarizing layer 220 ranges from 149 to 179 degrees.

By setting the included angles between the slow axes of the first phase retardation film and the second phase retardation film and the reflection axis of the reflective polarizing layer to 97 to 112 degrees and 149 to 179 degrees, respectively, the ratio of ghosting energy to main image energy can be greatly reduced. For example, the ratio of ghosting energy to main image energy is reduced to 1.5% or less, which is lower than the ratio of ghosting energy to main image energy (e.g., greater than 1.5%) in an image formed by the optical structure shown in FIG. 5 using a single-layer phase retardation film.

For example, as shown in FIGS. 9 and 10, the included angle between the slow axis H1 of the first phase retardation film 310 and the reflection axis P1 of the reflective polarizing layer 220 ranges from 97 to 110 degrees, and the included angle between the slow axis Q1 of the second phase retardation film 320 and the reflection axis P1 of the reflective polarizing layer 220 ranges from 149 to 175 degrees. For example, the included angle between the slow axis H1 of the first phase retardation film 310 and the reflection axis P1 of the reflective polarizing layer 220 ranges from 102 to 105 degrees, and the included angle between the slow axis Q1 of the second phase retardation film 320 and the reflection axis P1 of the reflective polarizing layer 220 ranges from 159 to 165 degrees.

By setting the included angles between the slow axes of the first phase retardation film and the second phase retardation film and the reflection axis of the reflective polarizing layer to 102 to 105 degrees and 159 to 165 degrees, respectively, the ratio of ghosting energy to main image energy can be greatly reduced. For example, the ratio of ghosting energy to main image energy is reduced to 1% or less, thereby significantly reducing the ratio of ghosting energy to main image energy.

For example, as shown in FIGS. 9 and 10, the included angle between the slow axis H1 of the first phase retardation film 310 and the reflection axis P1 of the reflective polarizing layer 220 ranges from 104 to 105 degrees, and the included angle between the slow axis Q1 of the second phase retardation film 320 and the reflection axis P1 of the reflective polarizing layer 220 ranges from 163 to 155 degrees, so that the ratio of ghosting energy to main image energy can be reduced to 0.9% or less.

For example, the included angle between the slow axis H1 of the first phase retardation film 310 and the reflection axis P1 of the reflective polarizing layer 220 ranges from 96 to 104 degrees, and the included angle between the slow axis Q1 of the second phase retardation film 320 and the reflection axis P1 of the reflective polarizing layer 220 ranges from 147 to 163 degrees, so that the ratio of direct ghosting energy to main image energy can be reduced to 0.3% or less.

For example, the included angle between the slow axis H1 of the first phase retardation film 310 and the reflection axis P1 of the reflective polarizing layer 220 ranges from 99 to 110 degrees, and the included angle between the slow axis Q1 of the second phase retardation film 320 and the reflection axis P1 of the reflective polarizing layer 220 ranges from 153 to 175 degrees, so that the ratio of twice-folded ghosting energy to main image energy can be reduced to 1.2% or less.

For example, the included angle between the slow axis H1 of the first phase retardation film 310 and the reflection axis P1 of the reflective polarizing layer 220 ranges from 101 to 160 degrees, and the included angle between the slow axis Q1 of the second phase retardation film 320 and the reflection axis P1 of the reflective polarizing layer 220 ranges from 157 to 275 degrees, so that the ratio of thrice-folded ghosting energy to main image energy can be reduced to 0.25% or less.

Thus, the included angles between the slow axes of the first phase retardation film and the second phase retardation film and the reflection axis of the reflective polarizing layer are optimized by comprehensively considering the ratios of the direct ghosting energy, the twice-folded ghosting energy and the thrice-folded ghosting energy to the main image energy.

In some examples, as shown in FIG. 9, the optical structure 10 further includes a first linear polarizing layer 230 on the side of the reflective polarizing layer 220 away from the transflective film 210, and the included angle between the slow axis of the first phase retardation film 310 and an absorption axis of the first linear polarizing layer 230 ranges from 90 to 180 degrees, for example from 97 to 112 degrees.

For example, as shown in FIG. 9, the absorption axis of the first linear polarizing layer 230 is parallel to the reflection axis of the reflective polarizing layer 220. For example, the transmission axis of the first linear polarizing layer 230 coincides with the transmission axis of the reflective polarizing layer 220. For example, the first linear polarizing layer 230 is used to further filter other stray light, and only polarized light (e.g., one of linearly s-polarized light and linearly p-polarized light) that passes through the first linear polarizing layer 230 is allowed to enter the human eye. For example, the material of the first linear polarizing layer 230 may include polyvinyl alcohol (PVA) to which dichroic molecules are added, a liquid crystal polymer film to which dichroic molecules are added, or the like.

For example, an anti-reflective film may be provided on the side of the first linear polarizing layer 230 away from the reflective polarizing layer 220.

In some examples, as shown in FIGS. 9 and 10, the included angle between the slow axis of the first phase retardation film 310 and the slow axis of the second phase retardation film 320 ranges from 45 to 135 degrees.

For example, the included angle between the slow axis of the first phase retardation film 310 and the slow axis of the second phase retardation film 320 ranges from 51 to 67 degrees.

In some examples, as shown in FIG. 9, the first phase retardation film 310 has a phase retardation of 202 and 249 nm, and the second phase retardation film 320 has a phase retardation of 102 to 128 nm.

By setting the phase retardation of the first phase retardation film to 202 to 249 nm and the phase retardation of the second phase retardation film to 102 to 128 nm, the ratio of ghosting energy to main image energy can be greatly reduced. For example, the ratio of ghosting energy to main image energy is reduced to 1.5% or less, which is lower than the ratio of ghosting energy to main image energy (e.g., greater than 1.5%) in an image formed by the optical structure shown in FIG. 5 using a single-layer phase retardation film.

For example, as shown in FIG. 9, the first phase retardation film 310 has a phase retardation of 215 to 228 nm, and the ratio of ghosting energy to main image energy can be reduced to 1% or less.

For example, the first phase retardation film 310 has a phase retardation of 202 to 228 nm, and the ratio of direct ghosting energy to main image energy can be reduced to 0.3% or less. For example, the first phase retardation film 310 has a phase retardation of 210 to 240 nm, and the ratio of twice-folded ghosting energy to main image energy can be reduced to 1.2% or less. For example, the first phase retardation film 310 has a phase retardation of 202 to 228 nm, and the ratio of thrice-folded ghosting energy to main image energy can be reduced to 0.23% or less.

For example, as shown in FIG. 9, the second phase retardation film 320 has a phase retardation of 108 to 120 nm, and the ratio of ghosting energy to main image energy can be reduced to 1% or less.

For example, the second phase retardation film 320 has a phase retardation of 102 to 115 nm, and the ratio of direct ghosting energy to main image energy can be reduced to 0.3% or less. For example, the second phase retardation film 320 has a phase retardation of 105 to 125 nm, and the ratio of twice-folded ghosting energy to main image energy can be reduced to 1.2% or less. For example, the second phase retardation film 320 has a phase retardation of 105 to 128 nm, and the ratio of thrice-folded ghosting energy to main image energy can be reduced to 0.23% or less.

After determining the preferred included angle range between the first phase retardation film and the second phase retardation film and the reflection axis of the reflective polarizing layer, adjusting the phase retardations of the first phase retardation film and the second phase retardation film, the ratio of ghosting energy to main image energy can be greatly reduced.

In some examples, as shown in FIG. 9, the first phase retardation film 310 includes a half-wave plate, and the second phase retardation film 320 includes a quarter-wave plate. Of course, the embodiments of the present disclosure are not limited thereto. The first phase retardation film 310 and the second phase retardation film 320 may further include a phase compensation film having a certain phase difference, such as a one-third wave plate, a one-fifth wave plate, a one-sixth wave plate, a two-third wave plate, etc. The embodiments of the present disclosure are not limited to the first phase retardation film group 300 including only a half-wave plate and a quarter-wave plate. Rather, the first phase retardation film group may further include other wave plates.

The second phase retardation film provided in the embodiments of the present disclosure employs a quarter-wave plate to enable the conversion between the linear polarization state and the circular polarization state of the light, and the first phase retardation film employs a half-wave plate to further enhance the effect of conversion between the linear polarization state and the circular polarization state.

In some examples, as shown in FIG. 9, the first phase retardation film 310 and the second phase retardation film 320 each include three refractive indices in three directions perpendicular to each other, the three refractive indices including a first refractive index, a second refractive index and a third refractive index. The first refractive index is the highest in-plane refractive index of the first phase retardation film 310 and the second phase retardation film 320, the second refractive index is the lowest in-plane refractive index of the first phase retardation film 310 and the second phase retardation film 320, and the third refractive index is a refractive index of the first phase retardation film 310 and the second phase retardation film 320 in a thickness direction.

For example, the first refractive index Nx1, the second refractive index Ny1, and the third refractive index Nz1 of the first phase retardation film satisfy the relationship: Nx1>Ny1≈Nz1. The first refractive index Nx2, the second refractive index Ny2, and the third refractive index Nz2 of the second phase retardation film satisfy the relationship: Nx2>Ny2≈Nz2.

For example, the first refractive index Nx1, the second refractive index Ny1, the third refractive index Nz1 and the thickness d1 of the first phase retardation film satisfy the relationship: Nx1>Ny1, and (Ny1−Nz1)*d1*1000<20 nm, where Δn1=Nx1−Ny1; and the first refractive index Nx2, the second refractive index Ny2, the third refractive index Nz2 and the thickness d2 of the second phase retardation film satisfy the relationship: Nx2>Ny2, and (Ny2−Nz2)*d2*1000<20 nm, where Δn2=Nx2−Ny2.

The expression “highest in-plane refractive index” may mean that when the phase retardation film is a planar film layer, the planar film layer has the highest refractive index Nx in the X direction and the lowest refractive index Ny in the Y direction, and the X direction may be the slow axis direction. For example, the planar film layer may be a film layer parallel to the XY plane, and the phase retardation is generated in the XY plane. When the phase retardation film is arranged on the curved surface of the lens 100, the values of the refractive indices in the two directions in the phase retardation film have a certain deviation from the refractive indices in the two directions in the case of a planar surface.

In some examples, as shown in FIG. 9, the first phase retardation film 310 and the second phase retardation film 320 are each made of a material that has a positive dispersion with respect to wavelength. The expression “positive dispersion with respect to wavelength” may mean that the phase retardation decreases as the wavelength of the light incident on the phase retardation film increases. For example, the phase retardation R0 of the first phase retardation film 310 decreases from less than 280 nm to between 200 and 240 nm as the wavelength increases from 380 nm to 780 nm, and the phase retardation R0 of the second phase retardation film 320 decreases from greater than 120 nm to between 80 and 120 nm as the wavelength increases from 380 nm to 780 nm.

The first phase retardation film group provided by the present disclosure includes a first phase retardation film and a second phase retardation film having positive dispersion characteristics with respect to wavelength. Due to the presence of the first phase retardation film, the entire retardation film set has better phase retardation and achromatic dispersion effects than a layer of quarter-wave plate that generally has reverse dispersion characteristics with respect to wavelength.

For example, as shown in FIG. 9, the material of the first phase retardation film 310 and the second phase retardation film 320 may be a stretched polymeric polymer such as polycarbonate (PC), cyclic olefin polymer (COP), etc. For example, the material of the first phase retardation film 310 and the second phase retardation film 320 may also be liquid crystal. For example, the liquid crystal layer may be aligned by means of an alignment layer, and the alignment direction is the slow axis direction of the phase retardation film. For example, at least one of the first phase retardation film 310 and the second phase retardation film 320 may be formed by coating, which is advantageous for reducing the cost. For example, it can be based on the existing liquid crystal coating type phase compensation film preparation and bonding process, which process is simple.

In some examples, as shown in FIG. 9, the first phase retardation film group 300 further includes a third phase retardation film 330. FIG. 9 schematically shows that the third phase retardation film 330 is located between the second phase retardation film 320 and the transflective film 210, but is not limited thereto. It is also possible that the third phase retardation film 330 is located between the first phase retardation film 310 and the second phase retardation film 320, or on the side of the first phase retardation film 310 away from the second phase retardation film 320.

In some examples, as shown in FIG. 9, the third phase retardation film 330 includes three refractive indices in three directions perpendicular to each other, the three refractive indices including a fourth refractive index Nx3, a fifth refractive index Ny3 and a sixth refractive index Nz3. The fourth refractive index and the fifth refractive index are in-plane refractive indices of the third phase retardation film, and the sixth refractive index is a refractive index of the third phase retardation film in a thickness direction.

For example, Nx3, Ny3, and Nz3 satisfy the relationship: Nx3≈Ny3<Nz3.

For example, the thicknesses d3 of the third phase retardation film, Nx3, Ny3, and Nz3 satisfy the relationship: Ny3<Nz3, and (Nx3−Ny3)*d3*1000<20 nm.

For example, the third phase retardation film 330 may also be referred to as a positive C film.

For example, the phase retardation Rth1 and the thickness d3 of the third phase retardation film, Nx3, Ny3 and Nz3 satisfy the relationship: Rth1=[(Nx3+Ny3)/2−Nz3]*d3.

For example, as shown in FIG. 9, the third phase retardation film 330 and the first phase retardation film 310 are different types of phase retardation films. For example, the phase retardation generated by the third phase retardation film 330 is not in-plane, for example, not in the XY plane. For example, the phase retardation generated by the third phase retardation film 330 is in the Z direction, such as the thickness direction of the third phase retardation film 330, such as the direction parallel to the optical axis of the lens 100.

In some examples, as shown in FIG. 9, the third phase retardation film 330 has a phase retardation Rth1 of −50 to −150 nm in the thickness direction.

By providing the third phase retardation film in the first phase retardation film group, it is helpful to improve the effect of conversion between the linear polarization state and the circular polarization state of the light with a large viewing angle. When the incident light is oblique, the third phase retardation film may be used to compensate for the additional retardation amount of the first phase retardation film and the second phase retardation film in the thickness direction, to avoid the adverse effect of the oblique incident light on the ellipticity, to ensure that the ellipticity is as close as possible to or equal to 1.

In some examples, as shown in FIG. 9, the third phase retardation film 330 has a phase retardation Rth1 of −70 to −110 nm in the thickness direction.

For example, as shown in FIG. 9, the material of the third phase retardation film 330 may be a stretched polymeric polymer such as polycarbonate (PC), cyclic olefin polymer (COP), etc. The material of the third phase retardation film 330 may alternatively be liquid crystal.

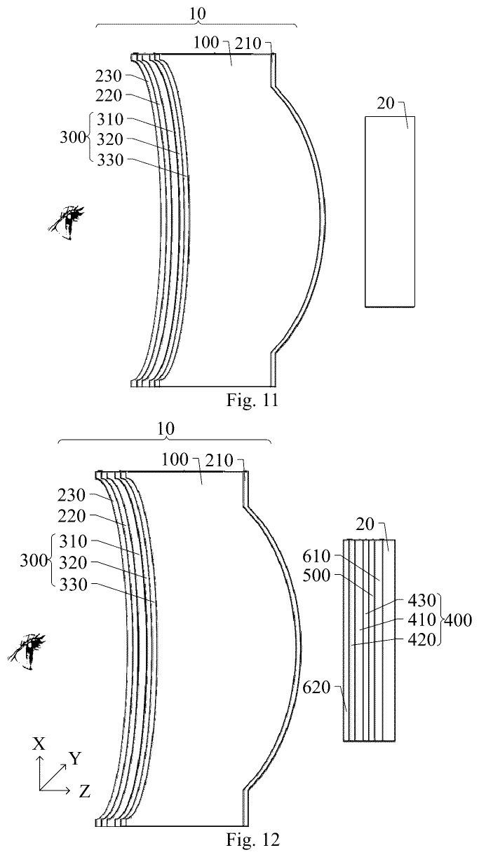

FIG. 11 is a schematic view of a display device according to another embodiment of the present disclosure. As shown in FIG. 11, the display device includes a display 20 and an optical structure 10. The optical structure 10 is located on a light exit side of the display 20, and the transflective film 210 is located between the display 20 and the reflective polarizing layer 220.

For example, in an example of an embodiment of the present disclosure, in the display device shown in FIG. 11, a linear polarizer 023, a compensation film 024, and a phase retarder 025 as shown in FIG. 5 may be provided between the display 20 and the optical structure 10. For example, the transmission axis of the linear polarizer may be orthogonal to the transmission axis of the first linear polarizing layer 230 in the optical structure 10.

FIG. 12 is a schematic view of a display device according to an example of another embodiment of the present disclosure.

In some examples, as shown in FIG. 12, a second phase retardation film group 400 and a second linear polarizing layer 500 are provided between the display 20 and the optical structure 10. An absorption axis of the second linear polarizing layer 500 is orthogonal to the reflection axis of the reflective polarizing layer 220. The second phase retardation film group 400 includes at least a fourth phase retardation film 410 and a fifth phase retardation film 420. The fifth phase retardation film 420 is located between the fourth phase retardation film 410 and the optical structure 10, a slow axis of the fourth phase retardation film 410 is orthogonal to the slow axis of the first phase retardation film 310, and a slow axis of the fifth phase retardation film 420 is orthogonal to the slow axis of the second phase retardation film 320.

The display device provided by the present disclosure further improve the efficiency of conversion between linearly polarized light and circularly polarized light by matching the characteristics of the film layers in the first phase retardation film group in the optical structure with the characteristics of the film layers in the second phase retardation film group between the display and the optical structure, thereby further reducing ghosting, stray light, etc.

For example, as shown in FIG. 12, the second linear polarizing layer 500 and the film layers in the second phase retardation film group 400 cooperate to convert unpolarized light emitted from the display 20 into circularly polarized light. The circularly polarized light passes through the transflective film 210 into the folded optical path of the optical structure 10.

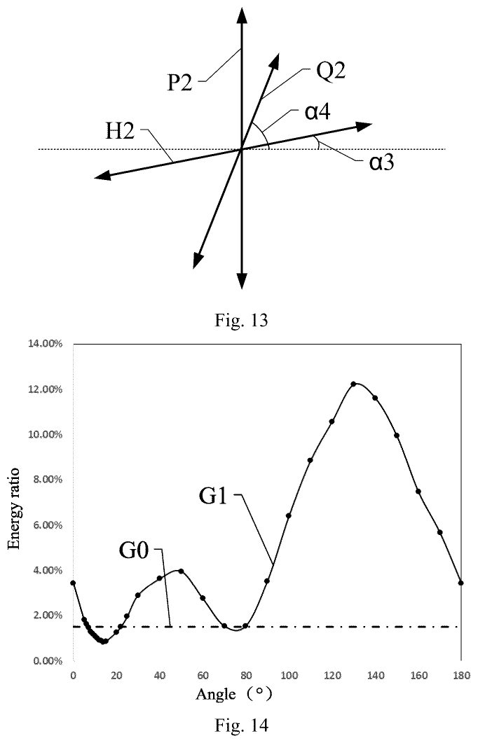

FIG. 13 shows an angular relationship among the slow axis of the third phase retardation film, the slow axis of the fourth phase retardation film, and a transmission axis of the second linear polarizing layer in the display device shown in FIG. 12.

In some examples, as shown in FIGS. 12 and 13, the included angle α3 between the slow axis H2 of the fourth phase retardation film 410 and the transmission axis of the second linear polarizing layer ranges from 0 to 90 degrees, and the included angle α4 between the slow axis Q2 of the fifth phase retardation film 420 and the transmission axis of the second linear polarizing layer 500 ranges from 45 to 225 degrees. FIG. 13 schematically shows the absorption axis P2 of the second linear polarizing layer 500. The transmission axis of the second linear polarizing layer 500 is orthogonal to the absorption axis P2.

In some examples, as shown in FIGS. 12 and 13, the included angle α3 between the slow axis H2 of the fourth phase retardation film 410 and the transmission axis of the second linear polarizing layer ranges from 6 to 22 degrees, and the included angle α4 between the slow axis Q2 of the fifth phase retardation film 420 and the transmission axis of the second linear polarizing layer ranges from 57 to 89 degrees.

By setting the included angles between the slow axes of the fourth phase retardation film and the fifth phase retardation film and the transmission axis of the second linear polarizing layer to 6 to 22 degrees and 57 to 89 degrees, respectively, to match the slow axes of the first phase retardation film and the second phase retardation film in the optical structure, it is helpful to greatly reduce the ratio of ghosting energy to main image energy.

For example, as shown in FIG. 12, the included angle between the slow axis of the fourth phase retardation film 410 and the slow axis of the fifth phase retardation film 420 ranges from 45 to 135 degrees. For example, the included angle between the slow axis of the fourth phase retardation film 410 and the slow axis of the fifth phase retardation film 420 ranges from 51 to 67 degrees.

For example, as shown in FIGS. 12 and 13, the included angle α3 between the slow axis H2 of the fourth phase retardation film 410 and the transmission axis of the second linear polarizing layer ranges from 12 to 15 degrees, and the included angle α4 between the slow axis Q2 of the fifth phase retardation film 420 and the transmission axis of the second linear polarizing layer ranges from 69 to 75 degrees, to reduce the ratio of ghosting energy to main image energy to 1% or less (see Table 1 below).

For example, as shown in FIGS. 12 and 13, the included angle α3 between the slow axis H2 of the fourth phase retardation film 410 and the transmission axis of the second linear polarizing layer ranges from 14 to 15 degrees, and the included angle α4 between the slow axis Q2 of the fifth phase retardation film 420 and the transmission axis of the second linear polarizing layer ranges from 73 to 75 degrees, to reduce the ratio of ghosting energy to main image energy to 0.9% or less (see Table 1 below).

For example, as shown in FIGS. 12 and 13, the included angle α3 between the slow axis H2 of the fourth phase retardation film 410 and the transmission axis of the second linear polarizing layer ranges from 6 to 14 degrees, and the included angle α4 between the slow axis Q2 of the fifth phase retardation film 420 and the transmission axis of the second linear polarizing layer ranges from 57 to 73 degrees, to reduce the ratio of direct ghosting energy to main image energy to 0.3% or less (see Table 1 below).

For example, as shown in FIGS. 12 and 13, the included angle α3 between the slow axis H2 of the fourth phase retardation film 410 and the transmission axis of the second linear polarizing layer ranges from 9 to 20 degrees, and the included angle α4 between the slow axis Q2 of the fifth phase retardation film 420 and the transmission axis of the second linear polarizing layer ranges from 63 to 85 degrees, to reduce the ratio of twice-folded ghosting energy to main image energy to 1.2% or less (see Table 1 below).

For example, as shown in FIGS. 12 and 13, the included angle α3 between the slow axis H2 of the fourth phase retardation film 410 and the transmission axis of the second linear polarizing layer ranges from 11 to 22 degrees, and the included angle α4 between the slow axis Q2 of the fifth phase retardation film 420 and the transmission axis of the second linear polarizing layer ranges from 67 to 89 degrees, to reduce the ratio of thrice-folded ghosting energy to main image energy to 0.25% or less (see Table 1 below).

Thus, the included angles between the slow axes of the first phase retardation film 310 and the second phase retardation film 320 and the reflection axis of the reflective polarizing layer 220 are matched with the included angles between the slow axes of the fourth phase retardation film 410 and the fifth phase retardation film 420 and the transmission axis of the second linear polarizing layer 500 by comprehensively considering the ratios of the direct ghosting energy, the twice-folded ghosting energy and the thrice-folded ghosting energy to the main image energy.

In some examples, as shown in FIG. 12, the fourth phase retardation film 410 has a phase retardation R04 of 200 to 280 nm, and the fifth phase retardation film 420 has a phase retardation R05 of 80 to 170 nm. The fourth phase retardation film and the fifth phase retardation film each include in-plane refractive indices in two different directions, the difference between the two different refractive indices of the fourth phase retardation film is Δn4, the difference between the two different refractive indices of the fifth phase retardation film is Δn5, Δn4, R04 and a thickness d4 of the fourth phase retardation film satisfy the relationship: R04=Δn4*d4, and Δn5, R05 and a thickness d5 of the fifth phase retardation film satisfy the relationship: R05=Δn5*d5.

The expression “phase retardation of the fourth phase retardation film 410” described above can refer to the in-plane phase difference R04 of 200 to 280 nm, and the expression “phase retardation of the fifth phase retardation film 420” described above can refer to the in-plane phase difference R05 of 80 to 170 nm. The phase difference Delta4 of the fourth phase retardation film satisfies the relationship: Delta4=2*π*R04/λ, and the phase difference Delta5 of the fifth phase retardation film satisfies the relationship: Delta5=2*π*R05/λ. The phase difference described above can refer to the phase difference at a specific wavelength λ. For example, λ may be 550 nm.

In some examples, as shown in FIG. 12, the fourth phase retardation film 410 has a phase retardation of 202 to 249 nm, and the fifth phase retardation film 420 has a phase retardation of 102 to 128 nm.

For example, as shown in FIG. 12, the difference between the phase retardation of the first phase retardation film 310 and the phase retardation of the fourth phase retardation film 410 is less than 10 nm, and the difference between the phase retardation of the second phase retardation film 320 and the phase retardation of the fifth phase retardation film 420 is less than 10 nm. For example, when the phase retardation of the first phase retardation film 310 is equal to the phase retardation of the fourth phase retardation film 410, the phase retardation of the second phase retardation film 320 is equal to the phase retardation of the fifth phase retardation film 420, and the slow axes are orthogonal to each other, the phase retardation of the light produced by the phase retardation film close to the display can just cancel the phase retardation of the light produced by the phase retardation film provided in a lens assembly, thereby ensuring that the light first reaching the reflective polarizer maintains the initial linear polarization state as much as possible, thereby reducing light leakage and reducing the proportion of direct ghosting.

In the display device provided by the present disclosure, by matching the phase retardations and the angles of the slow axes of the phase retardation films in the second phase retardation film group while setting the phase retardations and the angles of the slow axes of the phase retardation films in the first phase retardation film group in the optical structure, the efficiency of conversion between circularly polarized light and linearly polarized light is improved in the display device, thereby significantly improving the achromatic dispersion effect while effectively reducing ghosting and stray light of the folded optical path (pancake) caused by the unsatisfactory conversion of polarization states of the light.

In some examples, as shown in FIG. 12, the fourth phase retardation film 410 includes a half-wave plate, and the fifth phase retardation film 420 includes a quarter-wave plate. Of course, the embodiments of the present disclosure are not limited thereto. The fourth phase retardation film 410 and the fifth phase retardation film 420 may further include a phase compensation film having a certain phase difference, such as a one-third wave plate, a one-fifth wave plate, a one-sixth wave plate, a two-third wave plate, etc. The embodiments of the present disclosure are not limited to the second phase retardation film group 400 including only a half-wave plate and a quarter-wave plate. Rather, the second phase retardation film group may further include other wave plates.

The fifth phase retardation film provided in the embodiments of the present disclosure employs a quarter-wave plate to enable the conversion between the linear polarization state and the circular polarization state of the light, and the fourth phase retardation film employs a half-wave plate to further enhance the effect of conversion between the linear polarization state and the circular polarization state.

For example, as shown in FIG. 12, the fourth phase retardation film 410 and the fifth phase retardation film 420 each include three refractive indices in three directions perpendicular to each other, the three refractive indices including a first refractive index, a second refractive index and a third refractive index. The magnitude relationship of the first refractive index, the second refractive index, and the third refractive index of each of the fourth phase retardation film and the fifth phase retardation film may refer to the magnitude relationship of the first refractive index, the second refractive index, and the third refractive index of the first phase retardation film. The relationship of the phase retardation, the thickness, the first refractive index, and the second refractive index of each of the fourth phase retardation film 410 and the fifth phase retardation film 420 may refer to the relationship of the phase retardation, the thickness, the first refractive index and the second refractive index of the first phase retardation film.

In some examples, as shown in FIG. 12, the fourth phase retardation film 410 and the fifth phase retardation film 420 are each made of a material that has a positive dispersion with respect to wavelength. The expression “positive dispersion with respect to wavelength” may mean that the phase retardation decreases as the wavelength of the light incident on the phase retardation film increases.

Compared to the case where in a general display device only a single-layer quarter-wave plate having reverse dispersion characteristics is provided between the display and the folded optical path, and inside the folded optical path, the first phase retardation film group and the second phase retardation film group provided by the present disclosure each include a plurality of phase retardation films having positive dispersion characteristics with respect to wavelength, and can thus have better phase retardation and achromatic dispersion effects.

In some examples, as shown in FIG. 12, the second phase retardation film group 400 further includes a sixth phase retardation film 430, the sixth phase retardation film 430 having a phase retardation Rth2 of −70 to −110 nm in a thickness direction thereof. FIG. 12 schematically shows that the sixth phase retardation film 430 is located between the fourth phase retardation film 410 and the display 20, but is not limited thereto. It is also possible that the sixth phase retardation film 430 is located between the fourth phase retardation film 410 and the fifth phase retardation film 420, or on the side of the fifth phase retardation film 420 away from the fourth phase retardation film 410.

For example, as shown in FIG. 12, the sixth phase retardation film 430 includes three refractive indices in three directions perpendicular to each other, the three refractive indices including a fourth refractive index Nx4, a fifth refractive index Ny4 and a sixth refractive index Nz4. The fourth refractive index and the fifth refractive index are in-plane refractive indices of the sixth phase retardation film, the sixth refractive index is a refractive index of the sixth phase retardation film in a thickness direction, and the thickness d6 of the sixth phase retardation film, Nx4, Ny4 and Nz4 satisfy the relationship: Ny4<Nz4, and (Nx4−Ny4)*d6*1000<20 nm; and Rth2, d6, Nx4, Ny4, and Nz4 satisfy the relationship: Rth2=[(Nx4+Ny4)/2−Nz4]*d6.

For example, Nx4, Ny4, and Nz4 satisfy the relationship: Nx4≈Ny4<Nz4. For example, the sixth phase retardation film may also be referred to as a positive C film.

For example, as shown in FIG. 12, the sixth phase retardation film 430 and the fourth phase retardation film 410 are different types of phase retardation films. For example, the phase retardation generated by the sixth phase retardation film 430 is not in-plane, for example, not in the XY plane. For example, the phase retardation generated by the sixth phase retardation film 430 is in the Z direction, such as the thickness direction of the sixth phase retardation film 430, such as the direction parallel to the optical axis of the lens 100.

In some examples, as shown in FIG. 12, the sixth phase retardation film 430 has a phase retardation Rth2 of −50 to −150 nm in the thickness direction.

For example, as shown in FIG. 12, the difference between the phase retardation of the sixth phase retardation film 430 and the phase retardation of the third phase retardation film 330 is not more than 50 nm. For example, the sixth phase retardation film 430 may have the same phase retardation as the third phase retardation film 330.

By providing the sixth phase retardation film in the second phase retardation film group, it is helpful to improve the effect of conversion between the linear polarization state and the circular polarization state of the light with a large viewing angle.

For example, as shown in FIG. 12, the display device further includes a first anti-reflective layer 610 located between the second linear polarizing layer 500 and the display 20, and a second anti-reflective layer 620 located on the side of the second phase retardation film group 400 away from the display 20, to reduce the reflection on the surface between the second phase retardation film group 400 and air.

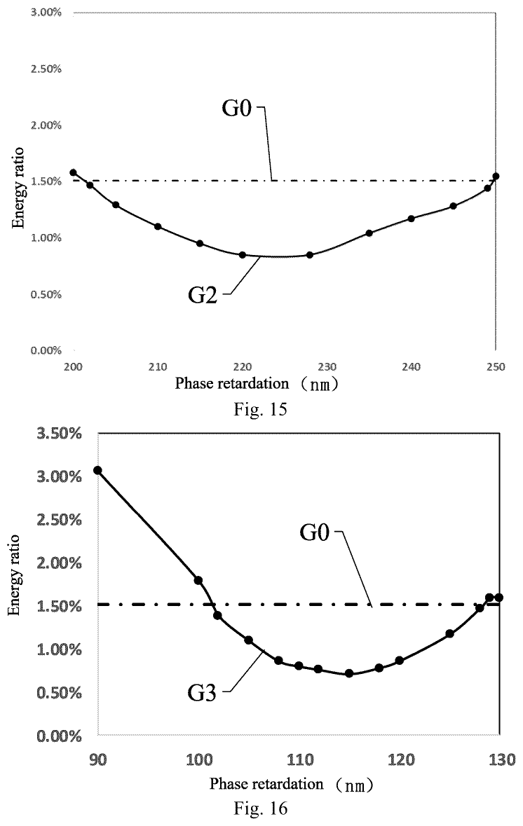

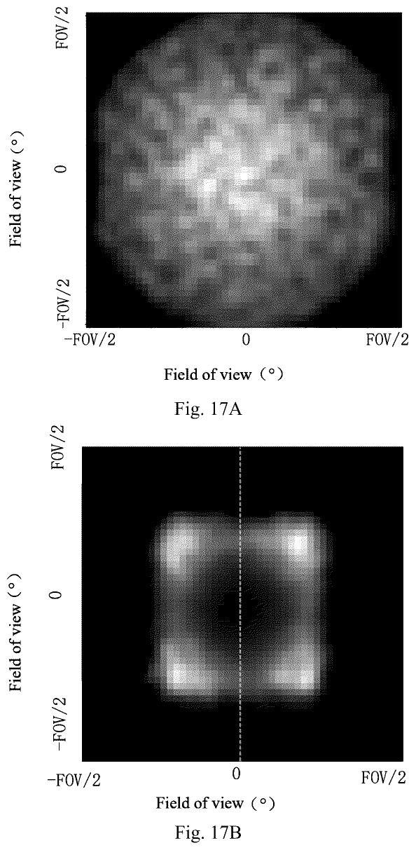

FIG. 14 is a curve of a variation of an energy ratio of a ghosting to a main image as an included angle between the slow axis of the fourth phase retardation film and the transmission axis of the second linear polarizing layer changes. FIG. 15 is a curve of a variation of an energy ratio of a ghosting to a main image as a phase retardation of the first phase retardation film changes. FIG. 16 is a curve of a variation of an energy ratio of a ghosting to a main image as a phase retardation of the second phase retardation film changes.

As shown in FIGS. 14 to 16, G0 represents the energy ratio of ghosting energy to main image energy when only one quarter phase retardation film is used in the optical structure, G1 represents the energy ratio of ghosting energy to main image energy with respect to the slow axis of the fourth phase retardation film 410, G2 represents the energy ratio of ghosting energy to main image energy with respect to the phase retardation of the first phase retardation film 310, and G3 represents the energy ratio of ghosting energy to main image energy with respect to the phase retardation of the second phase retardation film 320. The ghosting energies G1, G2, and G3 represent the weighted average of the energies of direct ghosting, twice-folded ghosting, and thrice-folded ghosting.

In the following Tables 1 to 3, a first energy ratio is the energy ratio of direct ghosting energy to main image energy, a second energy ratio is the energy ratio of twice-folded ghosting energy to main image energy, a third energy ratio is the energy ratio of thrice-folded ghosting energy to main image energy, and the total energy ratio is the weighted average of the above three ghosting energies.

The first phase retardation film, the second phase retardation film, the fourth phase retardation film, and the fifth phase retardation film shown in Table 1 are all phase retardation films in the display device shown in FIG. 12. The second phase retardation film and the fifth phase retardation film may correspond to the phase retarder on the lens and the phase retarder on the display, respectively, as shown in FIG. 5. Table 1 shows the energy ratio of ghosting to main image when the included angles between the slow axes of the first phase retardation film 310 and the second phase retardation film 320 and the reflection axis of the reflective polarizing layer 220 match the included angles between the slow axes of the fourth phase retardation film 410 and the fifth phase retardation film 420 and the transmission axis of the second linear polarizing layer 500 in the display device shown in FIG. 12. Table 1 also shows the energy ratio of ghosting to main image when the included angle between the slow axis of the second phase retardation film (e.g., the phase retarder 014) and the reflection axis of the reflective polarizer 015 matches the included angle between the slow axis of the fifth phase retardation film (e.g., the phase retarder 025) and the transmission axis of the linear polarizer 023 in the display device shown in FIG. 5. The display device shown in FIG. 5 does not include the first phase retardation film 310 and the fourth phase retardation film 410 shown in FIG. 12.

For example, Table 1 shows that in the display device shown in FIG. 12 in the embodiments of the present disclosure, the first phase retardation film 310 and the fourth phase retardation film 410 each have a phase retardation of 228 nm, the second phase retardation film 320 and the fifth phase retardation film 420 each have a phase retardation of 108 nm, and the third phase retardation film 330 has a phase retardation of −100 nm.

For example, as shown in Table 1, in the display device shown in FIG. 5, when the included angle between the slow axis of the second phase retardation film and the reflection axis of the reflective polarizing layer is 135 degrees, and the included angle between the slow axis of the fifth phase retardation film and the transmission axis of the second polarizing layer is 45 degrees, the total energy ratio of the ghosting is 1.51%.

For example, as shown in FIGS. 12 to 14 and Table 1, when the included angle α3 between the slow axis of the fourth phase retardation film 410 and the transmission axis of the second linear polarizing layer 500 ranges from 7 to 22 degrees and from 70 to 80 degrees, the energy ratio G1 is substantially lower than the energy ratio G0. For example, when the included angle α3 between the slow axis of the fourth phase retardation film 410 and the transmission axis of the second linear polarizing layer 500 ranges from 12 to 15 degrees, the total energy ratio of the ghosting is less than 1%.

For example, as shown in FIGS. 12 to 13 and Table 1, when the included angle α4 between the slow axis of the fifth phase retardation film 420 and the transmission axis of the second linear polarizing layer 500 ranges from 59 to 89 degrees and from 185 to 205 degrees, the energy ratio G1 is substantially lower than the energy ratio G0. For example, when the included angle α4 between the slow axis of the fifth phase retardation film 420 and the transmission axis of the second linear polarizing layer 500 ranges from 69 to 75 degrees, the total energy ratio of the ghosting is less than 1%.

For example, as shown in FIG. 10 and Table 1, when the included angle α1 between the slow axis of the first phase retardation film 310 and the reflection axis of the reflective polarizing layer 220 ranges from 97 to 112 degrees and from 160 to 170 degrees, the energy ratio G1 is substantially lower than the energy ratio G0. For example, when the included angle α1 between the slow axis of the first phase retardation film 310 and the reflection axis of the reflective polarizing layer 220 ranges from 102 to 105 degrees, the total energy ratio of the ghosting is less than 1%.

For example, as shown in FIG. 10 and Table 1, when the included angle α2 between the slow axis of the second phase retardation film 320 and the reflection axis of the reflective polarizing layer 220 ranges from 149 to 179 degrees and from 275 to 295 degrees, the energy ratio G1 is substantially lower than the energy ratio G0. For example, when the included angle α2 between the slow axis of the second phase retardation film 320 and the reflection axis of the reflective polarizing layer 220 ranges from 159 to 165 degrees, the total energy ratio of the ghosting is less than 1%.

By adjusting the included angles between the slow axes of the first phase retardation film and the second phase retardation film and the reflection axis of the reflective polarizing layer and also adjusting the included angles between the slow axes of the third phase retardation film and the fourth phase retardation film and the transmission axis of the second linear polarizing layer, the energy ratio of the ghosting can be significantly reduced, for example, is significantly lower than the energy ratio of the ghosting in a general display device.

TABLE 1

| | Fourth phase | Fifth phase | Second phase | First phase | First | Second | Third | Total |
|---|---|---|---|---|---|---|---|---|
| | retardation | retardation | retardation | retardation | energy | energy | energy | energy |
| | film (°) | film (°) | film (°) | film (°) | ratio | ratio | ratio | ratio |
| Display | — | 45 | 135 | — | 0.51% | 1.41% | 0.14% | 1.51% |
| device | | | | | | | | |
| shown in | | | | | | | | |
| FIG. 5 | | | | | | | | |
| Display | 0 | 45 | 135 | 90 | 0.66% | 3.36% | 0.32% | 3.44% |
| device | 5 | 55 | 145 | 95 | 0.29% | 1.76% | 0.29% | 1.81% |
| shown in | 6 | 57 | 147 | 96 | 0.29% | 1.59% | 0.27% | 1.64% |
| FIG. 12 | 7 | 59 | 149 | 97 | 0.26% | 1.42% | 0.29% | 1.47% |
| | 8 | 61 | 151 | 98 | 0.25% | 1.24% | 0.30% | 1.30% |
| | 9 | 63 | 153 | 99 | 0.25% | 1.15% | 0.29% | 1.21% |
| | 10 | 65 | 155 | 100 | 0.25% | 1.05% | 0.28% | 1.11% |
| | 11 | 67 | 157 | 101 | 0.25% | 0.96% | 0.25% | 1.03% |
| | 12 | 69 | 159 | 102 | 0.26% | 0.86% | 0.23% | 0.93% |
| | 13 | 71 | 161 | 103 | 0.27% | 0.83% | 0.23% | 0.91% |
| | 14 | 73 | 163 | 104 | 0.29% | 0.77% | 0.22% | 0.85% |
| | 15 | 75 | 165 | 105 | 0.31% | 0.78% | 0.19% | 0.86% |
| | 20 | 85 | 175 | 110 | 0.47% | 1.17% | 0.18% | 1.27% |
| | 22 | 89 | 179 | 112 | 0.57% | 1.38% | 0.15% | 1.50% |
| | 25 | 95 | 185 | 115 | 0.73% | 1.81% | 0.14% | 1.96% |
| | 30 | 105 | 195 | 120 | 1.02% | 2.71% | 0.13% | 2.90% |
| | 40 | 125 | 215 | 130 | 1.48% | 3.32% | 0.14% | 3.64% |
| | 50 | 145 | 235 | 140 | 1.55% | 3.65% | 0.18% | 3.97% |
| | 60 | 165 | 255 | 150 | 1.28% | 2.44% | 0.13% | 2.76% |
| | 70 | 185 | 275 | 160 | 1.07% | 1.09% | 0.22% | 1.54% |
| | 80 | 205 | 295 | 170 | 1.12% | 1.02% | 0.33% | 1.55% |
| | 90 | 225 | 315 | 180 | 1.56% | 3.15% | 0.36% | 3.53% |

The first phase retardation film shown in Table 2 is the phase retardation film in the display device shown in FIG. 12. The display device shown in FIG. 5 does not include the first phase retardation film. Table 2 shows the change in the energy ratio of the ghosting to the main image as the phase retardation of the first phase retardation film 310 in the display device shown in FIG. 12 gradually changes. FIG. 15 is a curve of a variation of an energy ratio of a ghosting to a main image as a phase retardation of the first phase retardation film changes.

For example, Table 2 shows that in the display device shown in FIG. 12 in the embodiments of the present disclosure, the included angle between the slow axis of the first phase retardation film 310 and the reflection axis of the reflective polarizing layer 220 is 104 degrees. The included angle between the slow axis of the second phase retardation film 320 and the reflection axis of the reflective polarizing layer 220 is 163 degrees, the second phase retardation film 320 has a phase retardation of 108 nm, the included angle between the slow axis of the fourth phase retardation film 410 and the transmission axis of the second linear polarizing layer 500 is 14 degrees, the included angle between the slow axis of the fifth phase retardation film 420 and the transmission axis of the second linear polarizing layer 500 is 73 degrees, the fifth phase retardation film 420 has a phase retardation of 108 nm, and the third phase retardation film 330 and the sixth phase retardation film each have a phase retardation of −100 nm.

For example, as shown in FIG. 15 and Table 2, the total energy ratio G0 of the ghosting to the main image of the display device shown in FIG. 5 is 1.51%.

For example, as shown in FIG. 15 and Table 2, when the first phase retardation film 310 in the display device shown in FIG. 12 has a phase retardation of 202 to 249 nm, the total energy ratio G2 of the ghosting is lower than the energy ratio G0. For example, when the first phase retardation film 310 has a phase retardation of 215 to 228 nm, the energy ratio G2 is less than 1%.

By adjusting the phase retardation of the first phase retardation film, the energy ratio of the ghosting can be significantly reduced.

TABLE 2

| | First phase | First | Second | Third | Total |
|---|---|---|---|---|---|
| | retardation | energy | energy | energy | energy |
| | film (nm) | ratio | ratio | ratio | ratio |
| Display | — | 0.51% | 1.41% | 0.14% | 1.51% |
| device | | | | | |
| shown in | | | | | |
| FIG. 5 | | | | | |
| Display | 200 | 0.29% | 1.55% | 0.15% | 1.58% |
| device | 202 | 0.28% | 1.43% | 0.16% | 1.47% |
| shown in | 205 | 0.28% | 1.24% | 0.18% | 1.29% |
| FIG. 12 | 210 | 0.28% | 1.04% | 0.20% | 1.10% |
| | 215 | 0.28% | 0.88% | 0.22% | 0.95% |
| | 220 | 0.28% | 0.78% | 0.19% | 0.85% |
| | 228 | 0.29% | 0.77% | 0.22% | 0.85% |
| | 235 | 0.30% | 0.97% | 0.25% | 1.04% |
| | 240 | 0.31% | 1.11% | 0.23% | 1.17% |
| | 245 | 0.32% | 1.22% | 0.22% | 1.28% |
| | 249 | 0.33% | 1.39% | 0.18% | 1.44% |
| | 250 | 0.33% | 1.51% | 0.19% | 1.55% |

The second phase retardation film shown in Table 3 is the phase retardation film in the display device shown in FIG. 12. The display device shown in FIG. 5 includes a second phase retardation film, such as the phase retarder 014. Table 3 shows the change in the energy ratio of the ghosting to main image as the phase retardation of the second phase retardation film 320 in the display device shown in FIG. 12 gradually changes. FIG. 16 is a curve of a variation of an energy ratio of a ghosting to a main image as a phase retardation of the second phase retardation film changes.

For example, Table 3 shows that in the display device shown in FIG. 12 in the embodiments of the present disclosure, the included angle between the slow axis of the first phase retardation film 310 and the reflection axis of the reflective polarizing layer 220 is 104 degrees, the first phase retardation film 310 has a phase retardation of 228 nm, the included angle between the slow axis of the second phase retardation film 320 and the reflection axis of the reflective polarizing layer 220 is 163 degrees, the included angle between the slow axis of the fourth phase retardation film 410 and the transmission axis of the second linear polarizing layer 500 is 14 degrees, the fourth phase retardation film 410 has a phase retardation of 228 nm, the included angle between the slow axis of the fifth phase retardation film 420 and the transmission axis of the second linear polarizing layer 500 is 73 degrees, and the third phase retardation film 330 and the sixth phase retardation film each have a phase retardation of −100 nm.

For example, as shown in FIG. 16 and Table 3, when the phase retardation film in the display device shown in FIG. 5 has a phase retardation of 141 nm, the total energy ratio G0 of the ghosting is 1.51%.

For example, as shown in FIG. 16 and Table 3, when the second phase retardation film 320 in the display device shown in FIG. 12 has a phase retardation of 102 to 128 nm, the total energy ratio G3 of the ghosting to the main image is lower than the energy ratio G0. For example, when the first phase retardation film 310 has a phase retardation of 108 to 120 nm, the energy ratio G3 is less than 1%.

By adjusting the phase retardation of the second phase retardation film, the energy ratio of the ghosting can be significantly reduced.

TABLE 3

| | Second phase | First | Second | Third | Total |
|---|---|---|---|---|---|
| | retardation | energy | energy | energy | energy |
| | film (nm) | ratio | ratio | ratio | ratio |
| Display | 141 | 0.51% | 1.41% | 0.14% | 1.51% |
| device | | | | | |
| shown in | | | | | |
| FIG. 5 | | | | | |
| Display | 90 | 0.28% | 3.04% | 0.19% | 3.06% |
| device | 100 | 0.28% | 1.75% | 0.25% | 1.79% |
| shown in | 102 | 0.28% | 1.34% | 0.23% | 1.38% |
| FIG. 12 | 105 | 0.29% | 1.03% | 0.22% | 1.09% |
| | 108 | 0.29% | 0.77% | 0.22% | 0.85% |
| | 110 | 0.29% | 0.70% | 0.21% | 0.79% |
| | 112 | 0.30% | 0.66% | 0.21% | 0.75% |
| | 115 | 0.30% | 0.61% | 0.19% | 0.70% |
| | 118 | 0.31% | 0.68% | 0.17% | 0.77% |
| | 120 | 0.32% | 0.77% | 0.17% | 0.85% |
| | 125 | 0.34% | 1.10% | 0.13% | 1.16% |
| | 128 | 0.36% | 1.42% | 0.12% | 1.46% |
| | 129 | 0.37% | 1.54% | 0.11% | 1.59% |
| | 130 | 0.37% | 1.54% | 0.10% | 1.59% |

As shown in Tables 1 to 3 and FIGS. 14 to 16, by coordinating the included angles between the slow axes of the first phase retardation film 310 and the second phase retardation film 320 and the reflection axis of the reflective polarizing layer 220, the included angles between the slow axes of the third phase retardation film 330 and the fourth phase retardation film 410 and the transmission axis of the second linear polarizing layer 500, the phase retardation of the first phase retardation film 310, and the phase retardation of the second phase retardation film 320, the energy ratio of the ghosting can be significantly reduced. For example, it is possible to adjust the angle of the slow axis of the phase retardation film first to lower the ghosting energy, and then adjust the phase retardation of the phase retardation film, so as to further reduce the ghosting energy. Of course, the embodiments of the present disclosure are not limited to this. It is also possible to adjust the phase retardation of the phase retardation film first and then adjust the angle of the slow axis of the phase retardation film.

For example, as shown in FIG. 12, in a first example of the present disclosure, the included angle between the slow axis of the first phase retardation film 310 and the reflection axis of the reflective polarizing layer 220 is 99 degrees, and the included angle between the slow axis of the second phase retardation film 320 and the reflection axis of the reflective polarizing layer 220 is 153 degrees. For example, the reflection axis of the reflective polarizing layer 220 and the absorption axis of the first linear polarizing layer 230 are both at 0 degrees, the slow axis of the first phase retardation film 310 is at 99 degrees, and the slow axis of the second phase retardation film 320 is at 153 degrees. The included angle between the slow axis of the fourth phase retardation film 410 and the transmission axis of the second linear polarizing layer 500 is 9 degrees, and the included angle between the slow axis of the fifth phase retardation film 420 and the transmission axis of the second linear polarizing layer 500 is 63 degrees. For example, the absorption axis of the second polarizing layer is at 90 degrees, the slow axis of the fourth phase retardation film 410 is at 9 degrees, and the slow axis of the fifth phase retardation film 420 is at 63 degrees. The first phase retardation film 310 and the fourth phase retardation film 410 each have a phase retardation of 228 nm, the second phase retardation film 320 and the fifth phase retardation film 420 each have a phase retardation of 108 nm, and the third phase retardation film 330 and the sixth phase retardation film each have a phase retardation of −100 nm. For example, an adhesive layer, such as pressure sensitive adhesive (PSA) or optically clear adhesive (OCA), is bonded between the film layers and between the film layer and the lens or the display 20.

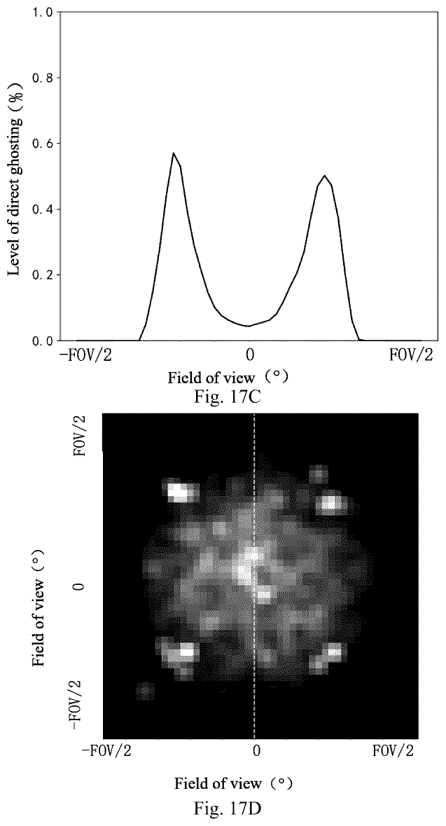

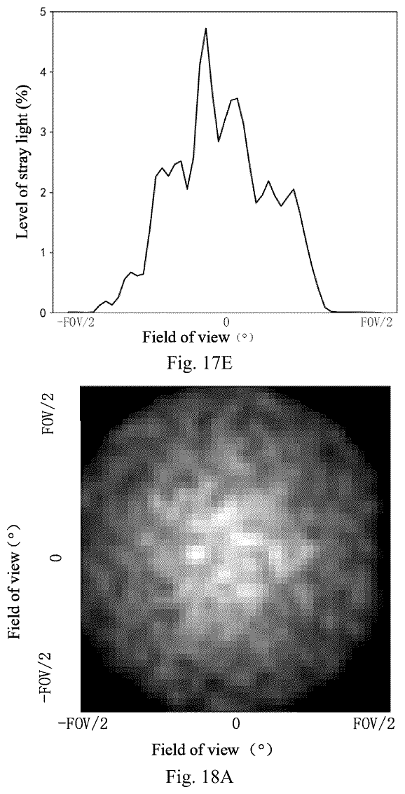

FIG. 17A is a diagram of a main image of the display device shown in FIG. 5 in a full field of view, FIG. 17B is a diagram of energy distribution of direct ghosting in the full field of view in the display device shown in FIG. 5, FIG. 17C shows the level of direct ghosting of the display device shown in FIG. 5 in the full field of view, FIG. 17D is a diagram of energy distribution of stray light caused by folded ghosting in the display device shown in FIG. 5 in the full field of view, and FIG. 17E shows the level of stray light of the display device shown in FIG. 5 in the full field of view. The level of direct ghosting refers to the ratio of the ghosting energy caused by direct light transmission to the main image energy, and the level of stray light refers to the ratio of the ghosting energy caused by twice folding to the main image energy.

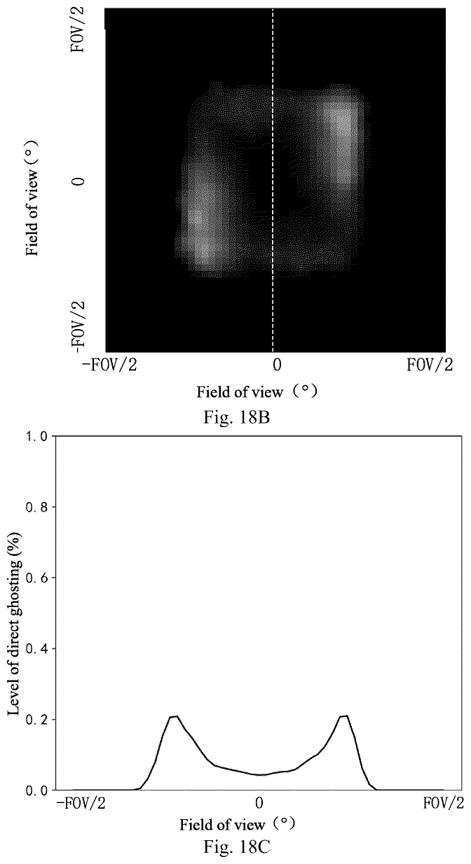

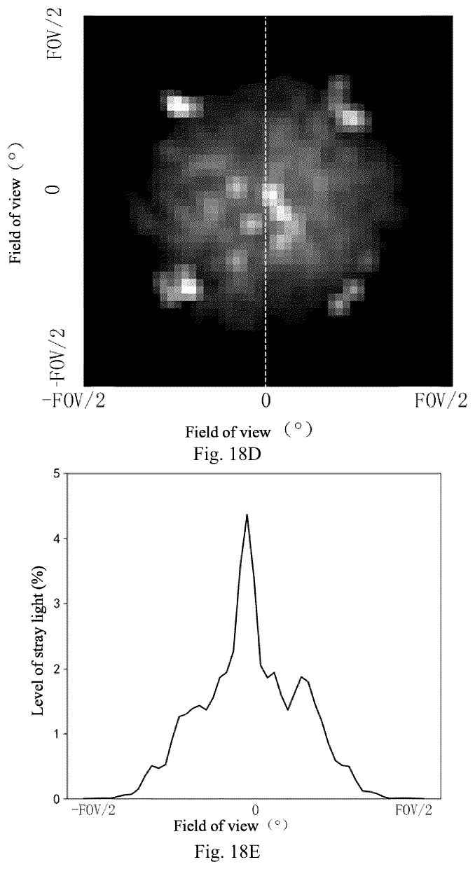

FIG. 18A is a diagram of a main image of a display device in a full field of view in the first example, FIG. 18B is a diagram of energy distribution of direct ghosting in the full field of view in the display device in the first example, FIG. 18C shows the level of direct ghosting of the display device in the full field of view in the first example, FIG. 18D is a diagram of energy distribution of stray light caused by folded ghosting in the display device in the full field of view in the first example, and FIG. 18E shows the level of stray light in the full field of view in the first example.

Referring to FIGS. 17B, 17C, 18B and 18C, compared to the display device shown in FIG. 5, the display device provided in the embodiments of the present disclosure is provided with the first phase retardation film group 300 and the second phase retardation film group 400 such that the average level of direct ghosting is reduced from 0.51% to 0.25%, such as by about 50%, thereby significantly reducing the level of direct ghosting.

Referring to FIGS. 17D, 17E, 18D and 18E, compared to the display device shown in FIG. 5, the display device provided in the embodiments of the present disclosure is provided with the first phase retardation film group and the second phase retardation film group such that the average level of stray light is reduced from 1.41% to 1.15%, such as by about 20%, thereby significantly reducing the level of stray light.

Thus, compared to the total energy ratio of 1.51% of the ghosting in the display device shown in FIG. 5, the display device provided in the embodiments of the present disclosure has a total energy ratio of about 1.21% of the ghosting, significantly reducing the total energy ratio of the ghosting.

For example, as shown in FIG. 12, in a second example of the present disclosure, the included angle between the slow axis of the first phase retardation film 310 and the reflection axis of the reflective polarizing layer 220 is 104 degrees, and the included angle between the slow axis of the second phase retardation film 320 and the reflection axis of the reflective polarizing layer 220 is 163 degrees. For example, the reflection axis of the reflective polarizing layer 220 and the absorption axis of the first linear polarizing layer 230 are both at 0 degrees, the slow axis of the first phase retardation film 310 is at 104 degrees, and the slow axis of the second phase retardation film 320 is at 163 degrees. The included angle between the slow axis of the fourth phase retardation film 410 and the transmission axis of the second linear polarizing layer 500 is 14 degrees, and the included angle between the slow axis of the fifth phase retardation film 420 and the transmission axis of the second linear polarizing layer 500 is 73 degrees. For example, the absorption axis of the second polarizing layer is at 90 degrees, the slow axis of the fourth phase retardation film 410 is at 14 degrees, and the slow axis of the fifth phase retardation film 420 is at 73 degrees. The first phase retardation film 310 and the fourth phase retardation film 410 each have a phase retardation of 228 nm, the second phase retardation film 320 and the fifth phase retardation film 420 each have a phase retardation of 108 nm, and the third phase retardation film 330 and the sixth phase retardation film each have a phase retardation of −100 nm. For example, an adhesive layer, such as pressure sensitive adhesive (PSA) or optically clear adhesive (OCA), is bonded between the film layers and between the film layer and the lens or the display 20.

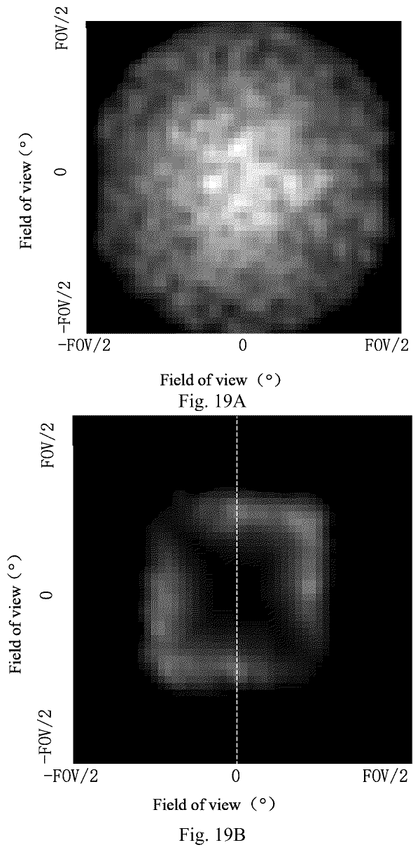

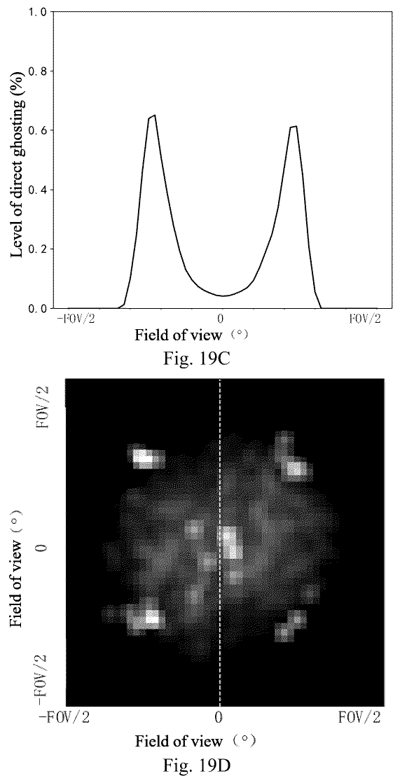

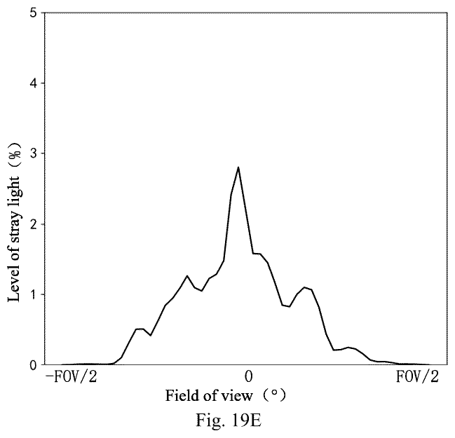

FIG. 19A is a diagram of a main image of a display device in a full field of view in the second example, FIG. 19B is a diagram of energy distribution of direct ghosting in the full field of view in the display device in the second example, FIG. 19C shows the level of direct ghosting of the display device in the full field of view in the second example, FIG. 19D is a diagram of energy distribution of stray light caused by folded ghosting in the display device in the full field of view in the second example, and FIG. 19E shows the level of stray light in the full field of view in the second example.

Referring to FIGS. 17B, 17C, 19B and 19C, compared to the display device shown in FIG. 5, the display device provided in the embodiments of the present disclosure is provided with the first phase retardation film group 300 and the second phase retardation film group 400 such that the average level of direct ghosting is reduced from 0.51% to 0.29%, such as by about 50%, thereby significantly reducing the level of direct ghosting.

Referring to FIGS. 17D, 17E, 19D and 19E, compared to the display device shown in FIG. 5, the display device provided in the embodiments of the present disclosure is provided with the first phase retardation film group and the second phase retardation film group such that the average level of stray light is reduced from 1.41% to 0.77%, such as by about 50%, thereby significantly reducing the level of stray light.

Thus, compared to the total energy ratio of 1.51% of the ghosting in the display device shown in FIG. 5, the display device provided in the embodiments of the present disclosure has a total energy ratio of about 0.85% of the ghosting, significantly reducing the total energy ratio of the ghosting.

The following statements should be noted:

(1) In the accompanying drawings of the embodiments of the present disclosure, the drawings

involve only the structure(s) in connection with the embodiment(s) of the present disclosure, and other structure(s) can be referred to common design(s).

(2) In case of no conflict, features in one embodiment or in different embodiments can be combined.

What have been described above are only specific implementations of the present disclosure, the protection scope of the present disclosure is not limited thereto, and the protection scope of the present disclosure should be based on the protection scope of the claims.

1. An optical structure, comprising:
at least one lens;
a transflective film located on a first surface of the at least one lens;
a reflective polarizing layer located on a second surface of the at least one lens; and
a first phase retardation film group located on a side of the first surface away from the transflective film,
wherein the first phase retardation film group comprises at least a first phase retardation film and a second phase retardation film, the second phase retardation film being located between the first phase retardation film and the transflective film,
the first phase retardation film has a phase retardation R01 of 200 to 280 nm, the second phase retardation film has a phase retardation R02 of 80 to 170 nm, an included angle between a slow axis of the first phase retardation film and a reflection axis of the reflective polarizing layer ranges from 90 to 180 degrees, and an included angle between a slow axis of the second phase retardation film and the reflection axis of the reflective polarizing layer ranges from 135 to 315 degrees; and
the first phase retardation film and the second phase retardation film each comprise in-plane refractive indices in two different directions, a difference between the two different refractive indices of the first phase retardation film is Δn1, a difference between the two different refractive indices of the second phase retardation film is Δn2, Δn1, R01 and a thickness d1 of the first phase retardation film satisfy a relationship: R01=Δn1*d1, and Δn2, R02 and a thickness d2 of the second phase retardation film satisfy a relationship: R02=Δn2*d2.

2. The optical structure according to claim 1, wherein the first phase retardation film has a phase retardation of 202 to 249 nm, and the second phase retardation film has a phase retardation of 102 to 128 nm.

3. The optical structure according to claim 1, wherein the included angle between the slow axis of the first phase retardation film and the reflection axis of the reflective polarizing layer ranges from 97 to 112 degrees, and the included angle between the slow axis of the second phase retardation film and the reflection axis of the reflective polarizing layer ranges from 149 to 179 degrees.

4. The optical structure according to claim 1, wherein an included angle between the slow axis of the first phase retardation film and the slow axis of the second phase retardation film ranges from 45 to 135 degrees.

5. The optical structure according to claim 4, wherein the included angle between the slow axis of the first phase retardation film and the slow axis of the second phase retardation film ranges from 51 to 67 degrees.

6. The optical structure according to claim 1, wherein the first phase retardation film and the second phase retardation film each comprise three refractive indices in three directions perpendicular to each other, the three refractive indices comprising a first refractive index, a second refractive index, and a third refractive index;
the first refractive index is the highest in-plane refractive index of the first phase retardation film and the second phase retardation film, the second refractive index is the lowest in-plane refractive index of the first phase retardation film and the second phase retardation film, and the third refractive index is a refractive index of the first phase retardation film and the second phase retardation film in a thickness direction;
the first refractive index Nx1, the second refractive index Ny1, the third refractive index Nz1 and the thickness d1 of the first phase retardation film satisfy a relationship: Nx1>Ny1, and (Ny1−Nz1)*d1*1000<20 nm, where Δn1=Nx1−Ny1; and
the first refractive index Nx2, the second refractive index Ny2, the third refractive index Nz2 and the thickness d2 of the second phase retardation film satisfy a relationship: Nx2>Ny2, and (Ny2−Nz2)*d2*1000<20 nm, where Δn2=Nx2−Ny2.

7. The optical structure according to claim 1, wherein the first phase retardation film and the second phase retardation film are each made of a material that has a positive dispersion with respect to wavelength.

8. The optical structure according to claim 1, wherein the first phase retardation film comprises a half-wave plate, and the second phase retardation film comprises a quarter-wave plate.

9. The optical structure according to claim 1, wherein the first phase retardation film group further comprises a third phase retardation film comprising three refractive indices in three directions perpendicular to each other, the three refractive indices comprising a fourth refractive index Nx3, a fifth refractive index Ny3, and a sixth refractive index Nz3; and
the fourth refractive index and the fifth refractive index are in-plane refractive indices of the third phase retardation film, the sixth refractive index is a refractive index of the third phase retardation film in a thickness direction, and a thickness d3 of the third phase retardation film, Nx3, Ny3 and Nz3 satisfy a relationship: Ny3<Nz3, and (Nx3−Ny3)*d3*1000<20 nm.

10. The optical structure according to claim 9, wherein the third phase retardation film has a phase retardation Rth1 of −50 to −150 nm in the thickness direction; and
Rth, d3, Nx3, Ny3 and Nz3 satisfy a relationship: Rth1=[(Nx3+Ny3)/2−Nz3]*d3.

11. The optical structure according to claim 10, wherein the third phase retardation film has a phase retardation Rth1 of −70 to −110 nm in the thickness direction.

12. The optical structure according to claim 1, further comprising:
a first linear polarizing layer located on a side of the reflective polarizing layer away from the transflective film,
wherein an included angle between the slow axis of the first phase retardation film and an absorption axis of the first linear polarizing layer ranges from 90 to 180 degrees.

13. A display device, comprising a display, and the optical structure of claim 1, wherein
the optical structure is located on a light exit side of the display, and the transflective film is located between the display and the reflective polarizing layer.

14. The display device according to claim 13, wherein a second phase retardation film group and a second linear polarizing layer are provided between the display and the optical structure, an absorption axis of the second linear polarizing layer is orthogonal to the reflection axis of the reflective polarizing layer; and
the second phase retardation film group comprises at least a fourth phase retardation film and a fifth phase retardation film, the fifth phase retardation film being located between the fourth phase retardation film and the optical structure, a slow axis of the fourth phase retardation film being orthogonal to the slow axis of the first phase retardation film, and a slow axis of the fifth phase retardation film being orthogonal to the slow axis of the second phase retardation film.

15. The display device according to claim 14, wherein the fourth phase retardation film has a phase retardation R04 of 200 to 280 nm, and the fifth phase retardation film has a phase retardation R05 of 80 to 170 nm; and
the fourth phase retardation film and the fifth phase retardation film each comprise in-plane refractive indices in two different directions, a difference between the two different refractive indices of the fourth phase retardation film is Δn4, a difference between the two different refractive indices of the fifth phase retardation film is Δn5, Δn4, R04 and a thickness d4 of the fourth phase retardation film satisfy a relationship: R04=Δn4*d4, and Δn5, R05 and a thickness d5 of the fifth phase retardation film satisfy a relationship: R05=Δn5*d5.

16. The display device according to claim 15, wherein the fourth phase retardation film has a phase retardation of 202 to 249 nm, and the fifth phase retardation film has a phase retardation of 102 to 128 nm.

17. The display device according to claim 14, wherein an included angle between the slow axis of the fourth phase retardation film and a transmission axis of the second linear polarizing layer ranges from 0 to 90 degrees, and an included angle between the slow axis of the fifth phase retardation film and the transmission axis of the second linear polarizing layer ranges from 45 to 225 degrees.

18. The display device according to claim 14, wherein the fourth phase retardation film and the fifth phase retardation film are each made of a material that has a positive dispersion with respect to wavelength.

19. The display device according to claim 14, wherein the fourth phase retardation film comprises a half-wave plate, and the fifth phase retardation film comprises a quarter-wave plate.

20. The display device according to claim 14, wherein the second phase retardation film group further comprises a sixth phase retardation film, the sixth phase retardation film having a phase retardation Rth2 of −50 to −150 nm in a thickness direction thereof;
the sixth phase retardation film comprises three refractive indices in three directions perpendicular to each other, the three refractive indices comprising a fourth refractive index Nx4, a fifth refractive index Ny4, and a sixth refractive index Nz4;
the fourth refractive index and the fifth refractive index are in-plane refractive indices of the sixth phase retardation film, the sixth refractive index is a refractive index of the sixth phase retardation film in a thickness direction, and a thickness d6 of the sixth phase retardation film, Nx4, Ny4 and Nz4 satisfy a relationship: Ny4<Nz4, and (Nx4−Ny4)*d6*1000<20 nm; and
Rth2, d6, Nx4, Ny4, and Nz4 satisfy a relationship: Rth2=[(Nx4+Ny4)/2−Nz4]*d6.
